(19) United States
(12) Patent Application Publication
(10) Pub. No.: US 2024/0190126 A1
(43) Pub. Date: Jun. 13, 2024

(54) TRANSFER FILM, PROCESS FOR PRODUCING A TRANSFER FILM AND PROCESS FOR RECYCLING A TRANSFER FILM

(71) Applicant: KURZ Stamping Technology (Hefei) Co., Ltd., Hefei (CN)

(72) Inventors: Yuxia SHI, Hefei (CN); Caiyu Ni, Hefei (CN); Janus Urbanek, Hefei (CN)

(21) Appl. No.: 18/527,803

(22) Filed: Dec. 4, 2023

(30) Foreign Application Priority Data
Dec. 12, 2022 (CN) 202211610207.1

(51) Int. Cl. B41F 19/00; B41F 16/00; B41F 23/00; B41M 1/10

(52) U.S. Cl. CPC B41F 19/008; B41F 16/0066; B41F 19/001; B41F 19/002; B41F 23/002; B41M 1/10

(57) ABSTRACT

A process for recycling a transfer film (1) and a transfer film (1) suitable for this having a carrier film (2) and a transfer ply (4) arranged at least partially on the carrier film (2), wherein a detachment layer (3) is arranged between the carrier film (2) and the transfer ply (4), and wherein the transfer ply (4) has an alkali-soluble topcoat (5), wherein the topcoat (5) is arranged on the detachment layer (3), and wherein the following step is carried out in the process:
x) dissolving (10) the alkali-soluble topcoat (5), in particular the alkali-soluble binder of the topcoat (5), by means of an alkaline washing liquid (9), preferably in a washing liquid bath, wherein the transfer ply (4) is detached from the carrier film (2).

### BACKGROUND OF THE INVENTION

The invention relates to a transfer film, a process for producing a transfer film and a process for recycling a transfer film.

It is known to use stamping films to decorate surfaces. For example, using coating processes, varnish layers, in particular varnish layers dyed or provided with dyes or pigments, and/or using vapor deposition processes, metal layers are applied to a non-water-soluble carrier film for this purpose. The transfer ply is then applied to the surface to be decorated together with the carrier film. For the decoration, in an application process the transfer ply is transferred to a suitable substrate over the whole surface or only in partial areas of surface. In the case of a hot-stamping application, the adhesion to the substrate is produced by a stamping die by means of thermal activation of a primer layer of the transfer ply. In the case of a cold-stamping application, before the decoration an adhesive layer is deposited on the areas of the substrate to be decorated or correspondingly on the transfer ply, which initiates the transfer of the transfer ply to the substrate. When the carrier film is subsequently peeled off, the transfer ply remains on the surface to be decorated and is detached from the carrier film in the area to be decorated. In order to make it possible to detach the transfer ply from the carrier film in the area to be decorated, detachment layers are arranged between the transfer ply and the carrier film in the stamping films. In particular, non-water-soluble waxes, which soften at higher temperatures and thus reduce the adhesive force between transfer ply and carrier film in a targeted manner, are used for such detachment layers.

In areas not to be decorated, the transfer ply is peeled off again together with the carrier film and thus remains on the carrier film in this partial area of surface. In the case of areas to be decorated which are only small, such as for example in the form of fine characters or line motifs, large quantities or partial areas of surface of the transfer ply remain on the carrier film as residual transfer ply. A further use of such a transfer film in a new stamping run is generally not possible or only possible in quite specific application machines and/or by means of quite specific application processes. The used carrier film with residual transfer ply must in all cases be disposed of, at times in a complex manner.

Recycling transfer films is of general interest in order to make a further use or recovery of the material of the carrier film and a separate disposal of remaining transfer ply possible after use of the transfer film in the case of transfer not over the whole surface during the application process. A recycling technique, which results in the separation of the transfer ply from the carrier film by means of mechanical processes or through the use of strong shear forces, is for example known from WO 2021/151742 A1. However, such processes have process-engineering disadvantages, such as e.g. high energy consumption and low throughput as well as often only incomplete detachment of the transfer ply from the carrier film, with the result that an unmixed recovery of the carrier film or of unmixed carrier film material, for example unmixed PET, is only possible to a limited extent. However, a reprocessing of the carrier film that is as unmixed as possible is desirable for a recovery of the material of the carrier film material, as small proportions of mixed contamination already result in substantial deficiencies in the quality of the recycling product. This applies similarly to the recovery of the material of a carrier film from a transfer film which has been produced with defects and thus represents a reject.

### SUMMARY OF THE INVENTION

The object of the invention is now to specify an improved transfer film which in addition has an improved recyclability.

The object is achieved by a transfer film, in particular a recyclable transfer film, wherein the transfer film has a carrier film and a transfer ply arranged at least partially on the carrier film, wherein a detachment layer is arranged between the carrier film and the transfer ply. It is essential that the transfer ply has an alkali-soluble topcoat, wherein the topcoat is arranged on the detachment layer.

The object is further achieved by a process for producing a transfer film, in particular according to claims 1 to 14, wherein the following steps are carried out, in particular in the following order:
providing a carrier film
applying a detachment layer to the carrier film, in particular by means of gravure printing process
applying one or more layers of a transfer ply, wherein an alkali-soluble topcoat is applied as first layer of the transfer ply, in particular by means of gravure printing process or slot die processes, such that the topcoat is arranged on the detachment layer.

This object is further achieved by a process for recycling a transfer film, in particular according to claims 1 to 14, preferably produced with a process according to claims 15 to 21, wherein the transfer film has a carrier film and a transfer ply arranged at least partially on the carrier film, wherein a detachment layer is arranged between the carrier film and the transfer ply, and wherein the transfer ply has an alkali-soluble topcoat, wherein the topcoat is arranged on the detachment layer, and wherein the following step is carried out in the process:
x) dissolving the alkali-soluble topcoat, in particular the alkali-soluble binder of the topcoat, by means of an alkaline washing liquid, preferably in a washing liquid bath, wherein the transfer ply is detached from the carrier film.

The transfer film according to the invention is preferably used in the process according to the invention for recycling a transfer film.

Such a transfer film and such a production and recycling process result in the advantage, in particular over energy recovery, that the recycled material of the carrier film can be used to produce new carrier films. It is also conceivable that the recycled plastic can be used for the production of other plastic products, for example injection-molded parts and/or extrusion parts. It is preferably provided that the transfer film is recycled both after an application process and when produced as rejects. It is possible here for the material of the carrier film to be recycled such that the resulting end product can be processed in further steps and has particularly good material properties.

In particular, the recyclability of the transfer film is improved here, as the use of an alkali-soluble topcoat makes a comparatively clean, simple and/or cost-effective recycling of a transfer film possible. The transfer film is recyclable here in particular in an alkaline washing liquid, such as for example an aqueous alkaline solution or lye.

By recyclability and recyclable is meant here in particular that all layers deposited on the carrier film can be completely detached again in a recycling process. In some circumstances, however, the detachment layer can remain on the carrier film. The detachment layer preferably has a negligibly small layer thickness in comparison with the layer thickness of the carrier film. Even if the detachment layer remains on the carrier film, this would have no effects on the material properties and/or the quality of the carrier material or plastic material obtained after the recycling because of the low relative proportion by weight of the detachment layer. In particular, the transfer ply can be removed from the carrier film residue-free.

In the case of recycling by means of the alkaline washing liquid, preferably by means of alkaline solution and/or by means of aqueous alkaline solution and/or by means of lye, a targeted separation of the transfer ply from the carrier film is made possible by the dissolution of the alkali-soluble topcoat, in particular of the alkali-soluble binder of the topcoat. The topcoat itself is part of the transfer ply. The topcoat is completely detached from the carrier film in the process. Depending on the proportion of the alkali-soluble binder in the topcoat, the proportion of the topcoat dissolved in the alkaline washing liquid can also be less than 100%. In step x), in particular, the carrier film is thus cleaned and the transfer film is thus released from the transfer ply. As mentioned above, the detachment layer can remain on the carrier film.

It is thereby possible in particular for a particularly pure material of the carrier film to be recovered. A particularly unmixed reprocessing of the carrier film for a further use or recovery of the material of the carrier film is thus advantageously made possible, which can for example also be re-used in further chemical or mechanical recycling steps. Contaminations, for example by the material of the transfer ply, which result in deficiencies in the quality of the recycling product or recyclate, are advantageously reduced or prevented.

In addition, the residual transfer ply is preferably detachable as a layer structure through the dissolution of the alkali-soluble topcoat, in particular of the alkali-soluble binder of the topcoat, wherein the layer structure is then present in particular as a cohesive solid in the alkaline washing liquid. Thus, advantageously, in particular in terms of a solubility in the alkaline washing liquid, no substances can be dissolved out of the layer structure of the transfer ply. Only in the case of metallized films with a metal layer made of a base metal can these base metals also dissolve. While the alkali-soluble topcoat remains in the washing liquid as a homogeneous solution, the detached insoluble transfer ply or residual transfer ply forms in particular a heterogeneous mixture with the washing liquid. The advantage is hereby achieved that substances which would no longer be able to be filtered out of the washing liquid, or in particular only with increased effort, can be reduced.

The transfer ply separated by the washing liquid, for example in the form of transfer ply constituents and/or transfer ply particles with a preferably heterogeneous composition, can for example also be processed in further separation processes which are chemical and in particular optimized for the transfer ply.

It has also proved to be advantageous that the alkaline soluble topcoat equally fulfills several functions. On the one hand, during the recycling of the transfer film, it ensures that the transfer ply is separated from the carrier film and on the other hand, if the transfer ply has been applied to a target substrate, it fulfills a decorative function and in addition represents a protective layer for the layers of the transfer ply arranged underneath the topcoat after the application.

The arrangement of the topcoat is preferably chosen such that it is in direct contact with the detachment layer. That is to say that in the process for producing the transfer film the topcoat is applied directly after the application of the detachment layer. Subsequently, still further layers can be applied to the topcoat as transfer ply. After the application of the transfer ply to a target substrate, the topcoat forms the uppermost layer.

The transfer film according to the invention is used for example on graphic packaging, greeting cards, documents, documents of value, certificates, labels or magazines.

Further advantageous embodiments of the invention are described in the dependent claims.

By an alkali-soluble topcoat is preferably meant here a layer consisting of one or more constituents, wherein at least one constituent is formed by an alkali-soluble binder. The alkali solubility of the topcoat is preferably achieved in that it comprises an alkali-soluble binder. In addition to the alkali-soluble binder, the topcoat can also have still other constituents, which are not alkali-soluble.

By packaging is meant here a general term which relates to both the sales packaging of a product and the outer packaging, for example the folded box of the product. The packaging can also be a part of an item of packaging, for example a label which is stuck onto an item of outer packaging. An item of packaging can also be a box or the like, in which several items of outer packaging of the product are packaged.

In the present case, by transparent is meant in particular an area with a transmissivity in the wavelength range of light visible to a human observer, in particular of from 380 nm to 780 nm, averaged over this wavelength range, of more than 50%, preferably of more than 70%, particularly preferably of more than 80%.

In the present case, by opaque is meant in particular an area with a transmissivity in the wavelength range of light visible to a human observer, in particular of from 380 nm to 780 nm, averaged over this wavelength range, of less than 40%, preferably of less than 30%, particularly preferably of less than 20%.

By a layer, by a ply and by a film is meant in particular a substantially two-dimensional structure which is in turn monolayer or multilayer. A film is preferably self-supporting. A layer or a ply is for example self-supporting or not self-supporting.

By a transfer film is meant in particular both a transfer film before its application, for example in an application process, in particular selected from: transfer process, hot-stamping process, cold-stamping process, laminating process, insert-molding process, in-mold decoration process, to a substrate or target object and the part of a transfer film not transferred to the substrate or target object after the application, as well as rejects. In the case where the transfer ply of the transfer film has been at least partially transferred to a substrate to be decorated, for example a component or a sheet material or a roll material, the transfer film then has in particular a carrier film with a residual transfer ply arranged thereon. The residual transfer ply describes the part of the transfer ply which has not been transferred to the substrate to be decorated and thus still remains on the carrier film. In the case of the rejects, the transfer ply remains in particular completely on the carrier film. The proportion by weight of the transfer ply relative to the carrier film is preferably larger in the case of rejects than in the case of already transferred transfer ply. It is thus preferably provided that, with the process, the transfer ply, in particular for example in the form of residual transfer ply, which is to be regarded essentially as foreign material, is removed from the carrier film.

Further, by the transfer film is meant in particular also a multiplicity of cut material, which is generated for example by a comminution of a transfer film. In particular, in step x) the carrier film of the transfer film is guided through the washing liquid in its entirety, thus preferably in one piece, or preferably cut material, which comprises carrier film and transfer ply in one structure, is put into the alkaline washing liquid. In particular, it is also conceivable that, instead of only one transfer film, several transfer films, in particular transfer films of the same type or of similar types, preferably at least with carrier film of the same type, are also used in the process for recycling a transfer film. The transfer ply is preferably present at least in areas on the carrier film before step x). By the carrier film is therefore preferably meant both the carrier film in its entirety and a multiplicity of cut material or carrier film cuttings. By the transfer ply is preferably meant both the transfer ply in its entirety and a multiplicity of particles of the transfer ply.

It is preferably provided that after step x) the carrier film and/or the material of the carrier film has a purity in the range of from 99.0 wt.-% to 100.0 wt.-% (wt.-%=percent by weight=proportion of the weight in percent of the total weight). The specification of the purity is preferably based on the proportion by mass of the material of the carrier film.

The purity of the carrier film or of the material of the carrier film can thus be improved in particular by a removal of the transfer ply and the alkali-soluble topcoat from the carrier film. As mentioned at the start, the detachment layer can possibly remain on the carrier film. However, even in this case at least a purity of the carrier film or of the material of the carrier film of 99.0 wt.-% or more is preferably achieved. The transfer ply and/or the transfer ply constituents of the transfer film are preferably regarded as foreign material in particular in the recycling process. The transfer ply and/or the transfer ply constituents can in each case be dissolved in the washing liquid or also be present undissolved.

Further, it is possible for the carrier film and/or the material of the carrier film to be colorless, transparent, crystal clear, opaque, dyed, at least partially dyed or colored after step x).

It is conceivable that before step x), in particular before step a) and/or before step b1), the transfer film has a foreign material proportion in the range of from 0 wt.-% to 5 wt.-%, preferably from 0 wt.-% to 1 wt.-%. Because the transfer films are sorted, in particular sorted in an unmixed way, before the actual recycling process, the downstream recycling process can be designed to be more efficient and the resulting material of the carrier film has improved material properties.

Further, it is preferably provided that before step x), in particular before step a) and/or b1), the transfer film has a proportion of adhesive strips and/or splicing tapes in the range of from 0 wt.-% to 0.5 wt.-%, preferably from 0 wt.-% to 0.1 wt.-%.

It is preferably possible for the topcoat, in particular the alkali-soluble binder of the topcoat, to be dissolved during step x) in that the alkaline washing liquid soaks into the transfer film, in particular into the transfer ply and/or between carrier film and transfer ply, via cut edges and/or broken edges and/or cracks and/or microcracks of the transfer film, in particular of the transfer ply, and in particular the topcoat swells as a result. Microcracks and/cracks form for example during the application of the transfer film to a target substrate. It is furthermore also possible for the alkaline washing liquid to diffuse through the alkali-insoluble layers and thus to come into contact with the topcoat and to dissolve the topcoat. When the topcoat, in particular the alkali-soluble binder of the topcoat, is dissolved, the rest of the transfer ply is separated from the carrier film. The transfer ply preferably disintegrates into particles, wherein the particles are insoluble in the alkaline washing liquid, in particular wherein the particles, in the case of a planar observation of the particles, have a size in the range of from 10 μm to 50 mm, preferably in the range of from 50 μm to 5 mm, particularly preferably in the range of from 20 μm to 5 mm. Due to the swelling of the topcoat, the disintegration of the transfer ply into particles is further accelerated. Depending on the pH of the alkaline washing liquid and possibly depending on the size of the cut material, the transfer ply can preferably already be completely detached from the carrier film after a duration of from 30 seconds to 120 seconds, preferably from 60 seconds to 120 seconds.

In particular, it is provided that in step x) the alkaline washing liquid has a pH greater than 9, preferably greater than 11, particularly preferably greater than 13. However, it is also possible for the alkaline washing liquid to have a pH greater than or equal to 14. In laboratory tests, the effect of the pH on the duration for dissolution of the alkali-soluble topcoat, in particular of the alkali-soluble binder of the topcoat, of a cut material of a transfer film with a size of 5 cm×5 cm was investigated. It has been shown that, in the case of a pH of 9, the topcoat, in particular the alkali-soluble binder of the topcoat, had been completely dissolved within 20 to 30 minutes. In the case of a pH of 11, on the other hand, this was already the case after 5 to 10 minutes. If a pH of 14 or more is used, the topcoat, in particular the alkali-soluble binder of the topcoat, can be dissolved within 10 to 20 seconds.

In addition, it has been shown that the size of the cut material also has an effect on the duration of the process of dissolving the topcoat, in particular the alkali-soluble binder of the topcoat. In tests, the dissolution behavior of cut materials of different sizes was investigated in each case in an alkaline washing liquid with a pH of 14 or more at a temperature of 25° C. It has been shown here that, in the case of a cut material with a surface area of 100 cm², the topcoat, in particular the alkali-soluble binder of the topcoat, had been completely dissolved after an exposure time in the alkaline washing liquid of up to 120 seconds. In the case of a cut material with a size of 25 cm², the topcoat or the binder had already been completely dissolved after an exposure time of up to 60 seconds.

It is further conceivable that the alkaline washing liquid comprises one or more solutions of the following solutions: solutions of alkali metal or alkaline earth metal hydroxides, such as potassium hydroxide, sodium hydroxide or calcium hydroxide; or alkaline earth oxides, such as calcium oxide or barium oxide; or solutions of ammonia or amines.

Furthermore, it is preferably provided that step x) is carried out at ambient temperature, in particular in a temperature range of from 15° C. to 30° C. The dissolution in step x) can, however, take place in any temperature range in which the alkaline washing liquid is in a liquid aggregate state. Ideally, however, a temperature which corresponds to the ambient temperature is suitable. A complex and expensive heating of the alkaline washing liquid can thereby be dispensed with.

It is also conceivable that the alkaline washing liquid has a density in the range of from 1.2 g/cm³ to 1.4 g/cm³, preferably in the range of from 1.25 g/cm³ to 1.35 g/cm³, in particular wherein the density of the alkaline washing liquid is chosen such that a sedimentation of the carrier film takes place due to differences in density. In particular in the case of a comminution step upstream of step x), the setting of the density of the alkaline washing liquid is advantageous. In this case, cut material is preferably put into a washing liquid bath. As already mentioned above, the alkaline soluble topcoat is dissolved, with the result that the transfer ply separates from the carrier film, wherein the transfer ply disintegrates into particles. Through a suitable choice of the density of the alkaline washing liquid, the cleaned carrier film cuttings settle on the bottom of the washing liquid bath, whereas the particles of the transfer ply float on the surface due to a lower density. These particles can then be easily separated from the washing liquid, for example with a sieve.

It is advantageously provided that the following step is carried out before step x) in the process:
a) comminuting the transfer film by means of a cutting device to form cut material, preferably wherein the transfer film is present wound onto a roll.

It is thus possible to put the transfer film into the alkaline washing liquid in the form of cut material. Advantageously, it is thereby made possible for the alkaline washing liquid to soak into the transfer film, in particular into the transfer ply and/or between carrier film and transfer ply, better via cut edges and/or broken edges. Generally, the smaller the cut material, the larger the surface area of the cut edges and/or broken edges relative to the surface area of the cut material. In the case of larger surface areas of the cut edges and/or broken edges, the alkaline washing liquid can thus dissolve the alkali-soluble topcoat, in particular the alkali-soluble binder of the topcoat, faster.

It is preferably provided that in step a) the cut material, in particular when observed perpendicular to a plane spanned by the cut material, has in each case a surface area in the range of from 0.1 cm² to 100 cm², preferably from 1 cm² to 10 cm².

In particular, it is provided that the cutting device in step a) comprises at least one device or combinations of devices selected from: guillotine, shredder, cutting mill, hammer mill and/or mill.

In particular, it is provided that the transfer ply is at least partially transferred to a substrate to be decorated, wherein a transfer film is provided as a by-product, before step x), in particular before step a) and/or before step b1), and preferably during the application process, in particular selected from: transfer process, hot-stamping process, cold-stamping process, laminating process, in-mold decoration process. It is preferably then a transfer film with a transfer ply in the form of a residual transfer ply. In this case, the residual transfer ply also comprises the alkaline soluble topcoat.

It is possible for the transfer film to be collected, in particular collected unmixed, by means of collection vessels. The collected transfer film can be uncut or alternatively also cut and/or shredded and/or compressed and/or pressed. It is preferably possible for the transfer film to be collected by means of collection vessels, in particular by means of a rack and/or container and/or transport box and/or banded bales, before step x), in particular before step a) and after the application process, preferably transfer process and/or laminating process and/or in-mold decoration process.

Banded bales preferably denote pressed transfer films the volume of which is minimized by pressing. In order to hold the pressed transfer films together, it is preferably provided that they are wrapped in bands, with the result that a banded bale is provided.

By unmixed is preferably meant that as far as possible only one transfer film is wound and/or collected on each roll. Good material properties of the recycled carrier film or of the recycled material of the carrier film are thus guaranteed.

It is thus possible for the process further to comprise the following step before step a):
collecting the transfer film by means of a collection vessel, in particular by means of a rack and/or container and/or transport box and/or banded bales.

It is preferably provided that the following step is further performed before step x), in particular before step a):
transporting the transfer film, in particular the cut material, by means of a feeder and/or by means of at least one transport container, in particular collection vessel and/or rack and/or container and/or transport box and/or banded bales and/or big bag, wherein the at least one transport container is filled with the cut material, in particular before step x).

By feeder is meant any transport vehicles and/or conveyor belts and/or pneumatic conveyors or the like.

It is also possible for the transfer film to be wound, in particular onto a film core, in the form of a roll before step x), in particular before step a) and/or before step b1), and after the application process, in particular selected from: transfer process, hot-stamping process, cold-stamping process, laminating process, in-mold decoration process. In a further embodiment, the transfer film is wound unmixed, in particular onto a film core. Alternatively, the winding in the form of a roll can also be effected without a film core, thus corelessly, and/or effected onto a film core which is removed from the film roll after the winding, with the result that the film roll is then present coreless. Such a removable film core can be for example part of a machine on which the transfer film is processed.

By film core is meant in particular a cardboard roll and/or a plastic roll and/or a machine part, onto which the transfer film is or has been wound. The film core can either remain in the film roll or be removed from the film roll again after the film roll has been wound.

It is thus possible for the following step to be performed before step a) and/or before the unwinding in step b1):
winding the transfer film, in particular onto a film core, with the result that a roll is provided.

Further, it is possible for the process to comprise the following step before step a) and/or before the unwinding in step x11):
transporting the roll to the unwinding device and/or transporting the roll and/or the collection vessel to the cutting device by hand and/or by means of a feeder.

The collecting or winding, in particular the unmixed collecting and/or winding, of the transfer film guarantees that the foreign material proportion is small. In step a) it is in particular also conceivable that, instead of one transfer film, several transfer films of one type are processed, in particular comminuted, at the same time.

During the comminution of the transfer film in step a), it is provided in particular that the wound transfer film is cut into film webs, wherein the roll with the transfer film is fixed in a V-shaped depression, in particular is fixed horizontally, and is then cut open to the film core in the longitudinal direction by means of a blade, in particular from above or from below or from the side, and the film core is removed, in particular if there is a film core. This has the advantage that the transfer film is easily detached from the film core quickly and can be used for further processing. The roll is preferably cut open in such a way that the blade cuts perpendicularly to a tangent of the lateral surface in the direction of the film core. In particular in the case of cutting from above, the advantage results that the roll is fixed by the V-shaped depression and no further counter bearings are needed to absorb the cutting pressure of the blade. It is preferably provided that this process step is performed by means of a guillotine.

As mentioned at the start, the film core preferably consists of a different material from the transfer film, which is why it is preferably provided that this film core, which acts as foreign material, is removed.

It is preferably possible for the cut material in the alkaline washing liquid to have a concentration in the range of from 1 wt.-% to 30 wt.-%, preferably from 5 wt.-% to 15 wt.-%, during step x), in particular if step a) is carried out beforehand. The concentration is preferably the solids concentration of the cut material in the washing liquid relative to the weight. Such a concentration guarantees that there is always enough alkaline washing liquid to dissolve the alkali-soluble topcoat of any cut material. In addition, clump formation is prevented.

The alkaline washing liquid is advantageously stirred with the transfer film and/or the cut material during step x), in particular if step a) is carried out beforehand. As a result, the soaking of the alkaline washing liquid into the transfer film or the cut material is accelerated. Here, the alkaline washing liquid is preferably stirred with a stirring duration in a range of from 30 seconds to 120 seconds, preferably from 60 seconds to 120 seconds. The stirring speed of a stirrer preferably lies in a range of from 1 to 200 revolutions, preferably from 10 to 50 revolutions, per minute.

Furthermore, it is possible for the transfer ply of the cut material to detach from the carrier film, with the result that particles of the transfer ply and carrier film cuttings form, during step x), in particular if step a) is carried out beforehand. Preferably, no particles are detached from the carrier film. This means that a carrier film cutting has the same surface area as a cut material, whereas, as mentioned above, the transfer ply disintegrates into particles.

It is preferably provided that the carrier film cuttings are separated from the alkaline washing liquid by means of filtration and/or centrifugation and/or sedimentation. As already described above, a sedimentation of the carrier film takes place due to differences in density. If a PET carrier film is used, the density of the alkaline washing liquid is advantageously set such that the carrier film cuttings settle on the bottom of the washing liquid bath. This process is also called sedimentation. On the other hand, the density of the alkaline washing liquid is also advantageously chosen such that the particles of the transfer ply separated off float in the washing liquid, preferably on the surface of the washing liquid. The particles can then be removed from the washing liquid, for example by means of a sieve. Subsequently, the carrier film cuttings can then be removed from the washing liquid for further processing.

For example, a PET carrier film has a density of approx. 1.4 g/cm³, whereas the materials of the layers of the transfer ply, for example of the primer layer or of the adhesion-promoter layer, have a density in the range of from 0.9 g/cm³ to 1.25 g/cm³. The described sedimentation can for example be achieved by setting the density of the alkaline washing liquid in a range of from 1.2 g/cm³ to 1.4 g/cm³, preferably in the range of from 1.25 g/cm³ to 1.35 g/cm³. The choice of the density of the alkaline liquid is preferably to be chosen depending on the material of the carrier film. Sedimentation offers the advantage over filtration or centrifugation that it can be carried out without additional energy.

It can further be possible for the separated carrier film cuttings to be washed and/or neutralized and/or dried, preferably by means of a mechanical and/or thermal drying process, in particular wherein a purity of the carrier film cuttings, in particular the carrier film material, in a range of from 99% to 100% is achieved. These process steps ensure that possible residues of the alkaline washing liquid remaining on the carrier film cuttings or possibly particles of the transfer ply are removed and in addition the moisture is extracted from the carrier film cuttings. A carrier film material that is as pure as possible is thereby obtained. At most a detachment layer remaining on the carrier film cuttings or the carrier film occurs as possible contamination here. As this has a negligibly small mass relative to the mass of the carrier film, as described at the start, a purity of the carrier film material of more than 99% can still be achieved.

As an alternative to the comminution, it is likewise preferably provided that the recycling process is carried out in a roll-to-roll process. Here, the transfer film is preferably guided through the washing liquid bath in its entirety and then the transfer film without transfer ply, thus only the carrier film, is wound up again, possibly with detachment layer present thereon.

It is preferably possible for the process to have the following step before step x):
b1) unwinding the transfer film from a feed roll by means of an unwinding device, wherein the unwound transfer film is brought into contact with the alkaline washing liquid, in particular by guiding the transfer film in a washing liquid bath.

Further, it is possible for a roughening and/or kiss-cutting and/or scratching of the transfer ply to be carried out between step b1) and step x). As a result, the alkali-soluble topcoat preferably has a larger contact surface for the alkaline washing liquid. The speed of the dissolution of the alkali-soluble topcoat, in particular of the alkali-soluble binder of the topcoat, can thus be increased. Here, the transfer film is preferably guided over a roll equipped with mechanical tools, for example with pins, with the result that preferably punctiform damage of the transfer ply is generated. The transfer film, in particular also the carrier film, can even be pierced as long as the transfer film can still remain sufficiently mechanically stable and does not tear. Corresponding tools, in particular pins, can have a spacing of from 1 mm to 5 mm over the width of the transfer film.

Furthermore, it is preferably provided that the process has the following step after step b1) and after step x):
b2) winding the carrier film onto a take-up roll, wherein the carrier film is guided out of the bath of the alkaline washing liquid, in particular wherein the topcoat in dissolved form and/or the transfer ply in undissolved form remains in the alkaline washing liquid.

Here, the separation of the carrier film in step x1) is made easier because the carrier film can be easily guided out of the washing liquid again by the winding. Here, the transfer ply preferably also separates from the carrier film because the transfer ply disintegrates into particles. These particles preferably float in the alkaline washing liquid. These particles of the transfer ply are also referred to as undissolved form of the transfer ply.

The transfer film, in particular the carrier film, is preferably guided through the alkaline washing liquid, preferably between step b1) and step b2), at a speed of from 1 m/min to 100 m/min. In particular, the transfer film, preferably the carrier film, is brought into contact with the washing liquid and/or guided through the washing liquid bath, preferably between step b1) and step b2), for a duration in a range of from 10 s to 150 s.

For example, it is possible to guide the transfer film, in particular the carrier film, through the washing liquid bath by means of one or more deflection rollers. It is hereby possible in particular to increase the residence time and to accelerate the dissolution of the alkali-soluble topcoat.

Further, it is possible for the carrier film to be guided through a cleaning bath, after the carrier film has been guided out of the washing liquid bath. Here, the carrier film is preferably brought into contact with a neutralizing cleaning liquid, which preferably comprises water and/or one or more acids selected individually or in combination from carbonic acid, acetic acid, hydrochloric acid, sulfuric acid. Thus, adhering lye can be neutralized or for example the pH can be set in the range of between 5 and 8. Further, it is possible to add alcohols selected individually or in combination from ethanol, n-propanol, isopropanol, butanol, acetone. Further, it is possible to add additives and/or surfactants, such as for example defoamers, to the cleaning liquid. Through the cleaning bath, residues of the alkaline washing liquid, which contains both proportions of the dissolved alkali-soluble topcoat and particles of the transfer ply and still wet the cleaned carrier film, can in particular preferably be removed. In particular, already precipitated particles of the transfer ply are preferably to be prevented from adhering to the cleaned carrier film. Before the winding onto the take-up roll, the carrier film is preferably guided out of the cleaning bath again.

It is also possible for the carrier film to be dried, after the carrier film has been guided out of the washing liquid bath and/or the cleaning bath. After the drying it is optionally possible to remove any loose residues of the transfer ply, in particular particles of the transfer ply, by means of a suction device and/or bonding device.

The process is thus carried out in particular in a roll-to-roll process and/or steps b1), x) and b2) are carried out in an inline process. It is also possible in an embodiment example for the production process and/or the application process for the transfer film to be carried out in an inline process within the process for recycling the transfer film, in particular with steps b1, x) and b2).

It is also conceivable that a mechanical abrasion system and/or a brush roll system and/or a foam roll system and/or a spray nozzle system is additionally used to detach the transfer ply from the carrier film in step x) and/or between steps b1) and b2). It is hereby possible in particular to accelerate the detachment of the transfer ply. In particular, it is conceivable to put the alkaline washing liquid, preferably additionally, by means of spray nozzles onto the side of the transfer film coated with the transfer plies, in order to achieve an even quicker detachment of the transfer ply.

It is preferably possible for insoluble particles of the transfer ply to be separated from the alkaline washing liquid by means of a separation process after step x), in particular wherein the separation process comprises filtration and/or centrifugation and/or sieving and/or decantation.

Furthermore, it is possible in particular for the alkaline washing liquid to be reprocessed by means of membrane filtration and/or chemical precipitation after step x). Constituents of the transfer ply dissolved in the alkaline washing liquid, such as for example the topcoat and possibly base metals of the metal layer, can hereby be removed from the washing liquid. The cleaned washing liquid can then be used again for the recycling of a further transfer film.

It is preferably provided that the carrier film and/or the carrier film cuttings and/or the material of the carrier film are further processed into a compact product and/or extrusion product after step x), in particular wherein the compact product and/or the extrusion product is suitable for at least one subsequent process or a combination of processes selected from: injection molding, extrusion, flat film extrusion, pressing processes, compounding, chemical recycling and/or energy recovery. Because the material of the carrier film and/or the carrier film and/or carrier film cuttings is present with a purity in the range of from 99.0% to 100.0% in the recycling process, subsequently produced products, such as for example injection-molded parts, extrusion parts, carrier films etc., also have such a purity, which in turn has a positive effect on the material properties of the recycling product.

The carrier film of the transfer film preferably has a layer thickness in the range of from 4.5 μm to 100 μm, preferably in the range of from 4.5 μm to 12 μm. The carrier film is preferably colorless, transparent, crystal clear, opaque, dyed, at least partially dyed or colored. The carrier film has been or is preferably produced by means of extrusion, in particular flat film extrusion. It is preferred that the carrier film consists of polyester or comprises polyester, in particular consists of or comprises one or more components or composite materials selected from polyethylene terephthalate (PET), polylactide, polyethylene furanoate, polybutylene terephthalate, polytrimethylene terephthalate, polyethylene naphthalate, and/or from polyester carbonate, cellophane, cellulose acetate, polyvinyl chloride, polyimide, polyvinylidene chloride and/or paper, in particular coated and/or laminated paper.

The carrier film expediently has a main constituent, preferably PET, wherein the proportion of the main constituent, preferably the PET, in the carrier film is more than 97%, preferably more than 99.9%, particularly preferably more than 99.97%. In order to improve the recyclability of the carrier film and also the material properties of the end product, it is preferably provided that the carrier material is present as pure as possible, i.e. no other foreign substances and/or plastics which are different from the carrier material are present. The main constituent of the carrier film is in particular PET.

In addition to the alkali-soluble topcoat, the transfer ply can also preferably have further layers selected individually or in combination from: at least one metal layer, at least one primer layer, at least one color layer, at least one adhesive layer, at least one adhesion-promoter layer, at least one barrier layer, at least one protective layer, at least one replication layer, at least one oxide layer, at least one mask layer. These further layers can in each case be present over the whole surface or only over part of the surface. The further layers can individually or as a combination of several layers form a pattern, a decoration, a grid, a geometric figure, a motif, alphanumeric character, logo, or combinations.

The color layer preferably consists of a combination of at least one binder and/or at least one filler as well as optionally at least one additive. By color layer is preferably meant a special, functional layer which generates in particular a color impression detectable for an observer.

By color is meant in particular a dyeing which, with respect to the transparency and/or the clarity or the scattering power, preferably comprises dyed crystal clear transparent, dyed scattering transparent or also dyed opaque. The color preferably occurs as an intrinsic color of a material and/or is arranged as an additional dyed layer as in front of a layer in the viewing direction, wherein the layer lying underneath it, in particular the metal layer, is in particular modified in terms of its colored appearance for an observer. Here, the color preferably appears optically constant or invariable in terms of its hue and/or its color saturation and/or in terms of its transparency from almost all, in particular from all, observation and/or illumination angles. It is further possible for the color itself to be optically variable, wherein the hue and/or the color saturation and/or the transparency of the color changes when the observation and/or illumination angle changes in particular.

The color layer is preferably formed as a glazing color layer, in particular as a transparently or translucently diaphanous color layer. Further preferably, the color layer preferably contains an additive and/or a filler, which preferably absorbs light in the ultraviolet wavelength range, in particular in a wavelength range of between 200 nm and 380 nm, in particular averaged over this wavelength range. In particular, the UV blockers have no or only a very low absorption in the wavelength range visible to the human eye of from 380 nm to 780 nm, in order in particular not to alter the color impression of the color layer.

Dyes and/or pigments are preferably suitable as coloring substances of the at least one color layer. Pigments are preferably practically insoluble, in particular insoluble, in the medium in which they are integrated. Dyes preferably dissolve during their use and in particular lose their crystalline and/or particulate structure. Possible classes of dyes are basic dyes, liposoluble dyes or metal complex dyes. Possible classes of pigments are organic and inorganic pigments. Pigments are preferably constructed from a material present in one piece or in particular alternatively have complex structures, for example as a layer structure with a plurality of layers of different materials and/or for example as capsules of different materials, in particular with a core and a shell.

The colors of the at least one color layer are in particular transparent or at least translucent, wherein the transmissivity preferably lies between 5% and 99%, in particular averaged over a partial region of the wavelength range visible to the human eye of from 380 nm to 780 nm, preferably in the range of from 430 nm to 690 nm.

Further, it is possible for the at least one color layer to be formed and/or to consist of several different colors, wherein here these preferably also have areas with color mixing of the first and second color, which form by means of overlapping of the color layers and/or by halftoning of the color layers. In particular, the color saturation in the color layers varies.

The color layer can be generated with at least one pigment or one colorant with the color cyan, magenta, yellow or black (CMYK=Cyan Magenta Yellow Key: black as color depth) or with the color red, green or blue (RGB) in particular to generate a subtractive mixed color.

In particular, it is provided that the at least one color layer has a layer thickness in the range of from 0.2 μm to 20 μm, preferably in the range of from 0.4 μm to 8 μm.

The metal layer preferably has a layer thickness in a range of from 5 nm to 50 nm, preferably in a range of from 10 nm to 40 nm. It is also possible for the metal layer to be transparent or opaque. The metal layer ensures in particular a metallic gloss and mirror effect, which can be perceived by an observer or sensor.

It is preferably possible for the metal layer to comprise or consist of materials and/or compounds, preferably with a high refractive index, selected individually or as an alloy of at least two of these materials or as a eutectic from: aluminum, chromium, silver, gold, copper, nickel, tin, indium, silicon oxide, magnesium oxide, titanium oxide, aluminum oxide, zinc oxide, zinc sulfide. Here, it is possible for the metal layer to be mono- or multilayer. In the case of the use of a metal layer made of one or more base metals, such as for example aluminum, it comes about, as mentioned above, during the immersion of the transfer film in the alkaline washing liquid bath that the metal layer made of base metal likewise dissolves. Here, hydrogen, among other things, can also be released. In particular, it is therefore provided that safety precautions, such as for example extraction by suction or ventilation, are taken.

The metal layer is preferably applied as one of the one or more layers of the transfer ply by means of vacuum vapor deposition. Comparatively thin layer applications are possible by means of a vacuum vapor deposition, with the result that layer thicknesses in the range of from 5 nm to 50 nm, preferably in the range of from 10 nm to 40 nm, can be achieved.

The primer layer has in particular a layer thickness of the dried layer in a range of from 0.1 μm to 5 μm, preferably in a range of from 0.5 μm to 3 μm and/or in a range of from 0.1 μm to 0.8 μm. A layer thickness of the dried layer in a range of from 0.1 μm to 0.8 μm is expedient in particular if the transfer film is a cold-stamping film. A layer thickness of the dried layer in a range of from 0.5 μm to 3 μm is expedient in particular if the transfer film is a hot-stamping film.

By means of the primer layer, it is possible for a sufficient adhesion of the transfer ply to the substrate or the target object to be guaranteed preferably during the application process and in particular also after the application process.

It is preferably possible for the primer layer to comprise or consist of one or more of the following materials: polyurethanes, polyesters, polyamides, polycarbonates, polyureas, polyacrylates and/or copolymers thereof, polymethacrylates and/or copolymers thereof, hydrocarbon resins, shellac, alkyd resins, colophony resins, ketone resins, phenolic resins, polystyrene resins, epoxy resins, maleic resins, melamine resins, formaldehyde resins, polyvinyl acetates, ethylene-vinyl acetate copolymers, polyvinyl chloride, nitrocellulose, polyolefins, modified polyolefins and/or plasticizers and/or dyes and/or organic and/or inorganic pigments and/or matting agents.

The primer layer is expediently applied as one of the one or more layers of the transfer ply by means of a printing process and/or by means of pouring and/or by means of doctor blade. For example, the primer layer is applied in a gravure printing process. In addition, it is possible for the primer layer to be applied with an application weight of the dry layer in the range of from 0.2 g/m² to 5.0 g/m², preferably wherein in the case of cold-stamping applications the primer layer is applied with an application weight of the dried layer in the range of from 0.2 g/m² to 1.0 g/m² and in the case of hot-stamping applications the primer layer is applied with an application weight of the dried layer in the range of from 0.5 g/m² to 5.0 g/m².

Depending on the application, an adhesion-promoter layer can for example be provided between the alkali-soluble topcoat and the metal layer. The adhesion between topcoat and metal layer is increased by the adhesion promoter.

In particular, it is possible for the adhesion-promoter layer to have a layer thickness in a range of from 0.01 μm to 0.5 μm, preferably in a range of from 0.01 μm to 0.3 μm. The adhesion-promoter layer comprises or preferably consists of one or more of the following materials: polyurethanes, polyesters, polyamides, polycarbonates, polyacrylates and/or copolymers thereof, polymethacrylates and/or copolymers thereof, hydrocarbon resins, alkyd resins, colophony resins, ketone resins, phenolic resins, polystyrene resins, epoxy resins, polyvinyl acetates, ethylene-vinyl acetate copolymers, polyvinyl chloride, nitrocellulose, polyolefins and/or modified polyolefins.

A further adhesion-promoter layer can also be provided between the metal layer and a further layer which is arranged on the side of the metal layer facing away from the topcoat.

The detachment layer preferably comprises a material or a combination of materials selected from: waxes, silicones, polyurethanes, fluorinated compounds, fluorinated fatty acids, modified silicone waxes and silicone resins, unmodified silicone waxes and silicone resins, polymers, preferably acrylate copolymers, polyester copolymers, polystyrene copolymers, polycarbonate copolymers. The detachment layer is preferably alkali-insoluble. This offers the advantage that during the recycling of the transfer film the detachment layer does not dissolve in the alkaline washing liquid. The alkaline washing liquid is thus prevented from having to be reprocessed in a complex manner after the recycling process.

It is preferably possible for the detachment layer to have a layer thickness of the dried layer in the range of from 0.001 μm to 0.080 μm, preferably from 0.004 μm to 0.050 μm. This comparatively small thickness of the detachment layer allows a sharp-edged and clean detachment of the transfer ply from the carrier film.

The detachment layer is preferably applied by means of a gravure printing process with an application weight of the dried layer in the range of from 0.001 g/m² to 0.060 g/m², preferably from 0.005 g/m² to 0.050 g/m².

In particular, it is advantageous if the detachment layer is formed transparent and/or translucent and/or opaque and/or dyed and/or at least partially dyed and/or crystal clear.

In particular, the detachment layer improves the transfer of the transfer ply in an application process, for example in a transfer process and/or laminating process and/or in-mold decoration process, to a substrate surface, preferably by thereby reducing the detachment force for detaching the transfer ply from the carrier film.

The layers applied to the carrier film, in particular the detachment layer and the transfer ply, advantageously have a sufficient adhesion to one another and to the carrier film, in order in particular to prevent an uncontrolled detachment of the entire transfer ply or individual layers of it from the carrier film, for example during winding and unwinding, during transport or during storage. The detachment force for detaching the transfer ply from the carrier film, in particular at temperatures in the range of from 15° C. to 35° C., preferably lies in a range of from 1 cN/cm to 10 cN/cm, in particular in the case of cold-stamping films preferably in the range of from 1 cN/cm to 3 cN/cm, and/or in particular in the case of hot-stamping films preferably in the range of from 2 cN/cm to 5 cN/cm.

The detachment forces between the individual transfer ply layers, in particular the alkali-soluble topcoat and/or the metal layer and/or the primer layer and/or the adhesion-promoter layer and/or the color layer, are preferably larger than the force for detaching the transfer ply from the carrier film. As a result of this, in particular, a complete transfer of the transfer ply to the substrate in the areas to be transferred is made possible in the application process. Further, a breaking or splitting of the transfer ply during the application process is prevented.

It is preferably provided that the smallest detachment force within or between two or more layers of the transfer ply is at least twice as large as the force for detaching the transfer ply from the carrier film, in particular lies in a range of from 10 cN/cm to 100 cN/cm, preferably at least 20 cN/cm to 100 cN/cm, particularly preferably at least 40 cN/cm to 100 cN/cm.

For the measurement of the force for detaching the transfer ply from the carrier film, a double-sided adhesive tape is preferably stuck onto a rigid surface with a length of 25 cm and a width of 10 cm over the whole surface without bubbles. Then a strip of the transfer film with a length of 30 cm and a width of 10 cm is stuck on the adhesive tape with the transfer ply side without bubbles such that a tab of a 5-cm film overhang remains. The stuck-on transfer film is pressed on firmly, the overhanging tab is secured to the measuring unit of a material testing machine of the Z005 type from ZwickRoell GmbH & Co. KG and the carrier film is peeled off at a peel angle of 90° and a speed of 50 cm/min. The force necessary in this case is measured and specified in cN per cm film width.

Preferably at least 40% to 100% of the topcoat comprises a binder or binder mixture, which is at least 50%, preferably at least 75%, soluble in an alkaline washing liquid, in particular lye or alkaline solution, with a pH greater than 8.5, preferably greater than 10. In particular, such binders are referred to as ASRs (ASR=alkali-soluble resins) and comprise hydrophobic areas and carboxylic acid groups. These functional groups are, as the pH increases, deprotonated at suitable alkaline pH and increase the polarity of the polymer such that it becomes completely soluble in a polar solvent such as water or is present at least as a colloidal dispersion. The deprotonation is a reversible process. The binder is insoluble in neutral water (pH ˜7) or acidic aqueous solutions (pH less than 7) as the hydrophobic character of the binder predominates in the case of protonated carboxylic acid groups.

As the deprotonation is a reversible process, this property can also advantageously be adopted for the application of the alkali-soluble topcoat. Here, it is preferably provided that the topcoat is applied in the aqueous state and is then dried, wherein alkaline additives are completely or at least partially removed by drying. Through the removal of the alkaline additives by drying, the topcoat becomes solid.

It is preferably provided that the aqueous topcoat has a solids content in the range of from 5% to 45%, preferably in the range of from 15% to 30%, particularly preferably in the range of from 15% to 25%. An advantageous printing viscosity is thereby achieved.

It is also possible for the topcoat to be applied with an application weight of the dried layer in the range of from 0.5 g/m² to 20.0 g/m², preferably in the range of from 0.8 g/m² to 10.0 g/m². In particular a slot die process or a gravure printing process are advantageously suitable for applying the topcoat. The topcoat is preferably applied directly to the detachment layer, with the result that the topcoat is applied as first layer of the transfer ply.

Furthermore, it is possible for the topcoat to be transparent, semitransparent, transparent dyed, dyed, opaque and/or matte. It is also possible for the topcoat to have a layer thickness of the dried layer in the range of from 0.2 μm to 20 μm, preferably in the range of from 0.4 μm to 8 μm.

As already mentioned at the start, the alkali-soluble topcoat equally fulfills several functions. On the one hand, the alkali solubility of the topcoat can advantageously be utilized for the application of the topcoat during the production process. During the recycling process, on the other hand, this alkali solubility of the topcoat is utilized for the separation of the transfer ply from the carrier film. After the application of the transfer ply to a target substrate, the topcoat represents the uppermost layer and thus protects the underlying layers of the transfer ply, such as for example metal layer, color layer and/or primer layer, from external environmental influences.

Due to the alkali solubility of the topcoat, it must preferably be ensured that the topcoat still has a sufficient resistance after the application to a target substrate and thus in the actual field of use. As already mentioned above, during the drying of the aqueous topcoat, alkaline additives, such as ammonia or amines, in particular ammonia predominantly, are completely or at least partially removed by drying. After the drying, the topcoat, in particular the binder of the topcoat, is preferably present in the protonated state. In this state, the topcoat, in particular the binder of the topcoat, is hydrophobic and thus water-insoluble. For the use of the alkali-soluble topcoat for transfer decorations on graphic packaging, greeting cards, labels or magazines, a low to no solubility of the topcoat on contact with moisture or neutral water is necessary in order to withstand damage in everyday use. By moisture is meant here, for example, also a person's sweat, with which the topcoat comes into contact when the greeting card for example or the magazine is touched.

The resistance of the alkali-soluble topcoat was tested in laboratory tests for this.

In a first test, a transfer ply with alkali-soluble topcoat applied to a water-resistant substrate was investigated for possible changes during a one-hour exposure to neutral water with a pH in the range of from 6 to 7. After the exposure to the water, the transfer ply or the alkali-soluble topcoat was wiped off with a cotton cloth and then dried for a duration of one hour under ambient conditions with a temperature of 25° C. and a relative humidity in the range of from 40% to 60%. Advantageously, no visually perceptible changes in the alkali-soluble topcoat were detected.

In a second test, the resistance of the alkali-soluble topcoat to abrasion was investigated. For this, a so-called crockmeter test according to AATCC test method 8, which is preferably known from the textile industry, was carried out. First of all, the transfer ply with the alkali-soluble topcoat was applied to a water-resistant substrate. A substrate made of ABS(=acrylonitrile butadiene styrene) is preferably suitable for this. Then, ten complete rubbing movements were carried out on the surface of the alkali-soluble topcoat with a dry or moistened cotton cloth under a vertical force effect of 5 N. The moistened cotton cloth has a pH of from 6 to 7 here. In this test too, no visually perceptible changes in the alkali-soluble topcoat were detected.

The first two tests relate to the resistance of the topcoat after the application to a substrate. However, it is also preferably provided that the thermal resistance of the topcoat, in particular in the case of a hot-stamping application, is good enough in order not to soften and thus, where appropriate, to preserve the integrity of the thin metal mirror. The metal mirror is preferably realized in the form of a vapor-deposited metal layer. A softening of the alkali-soluble topcoat during the hot stamping would have the result that the topcoat becomes cloudy and the gloss of the underlying metal layer is thus no longer perceptible to an observer. For this reason, in a third test, the thermal resistance of the alkali-soluble topcoat was investigated in comparison with conventional solvent-based topcoats during the hot-stamping application. For this, hot stampings were carried out in each case for the transfer film according to the invention and conventional transfer films with solvent-based topcoat on a Yuheng MK920 vertical hot-stamping machine with a stamp temperature of 130° C. and a throughput of 4000 sheets per hour. The visual check revealed that the gloss and the reflectance of the metal mirror including the alkaline soluble topcoat is almost identical to a conventional transfer film with solvent-based topcoat.

The tests described have shown that, in terms of visually perceptible changes, the alkali-soluble topcoat has a similar resistance to conventional solvent-based topcoats. Thus, articles or substrates applied or decorated with the transfer film according to the invention can be used for everyday applications. For example, a decorated item of packaging of a product or foodstuff to be cooled in a refrigerator can be used. The tests have shown that the alkali-soluble topcoat has a sufficient resistance to for example condensed water occurring in a refrigerator.

The process according to the invention is suitable in particular for recycling transfer films the transfer plies of which consist of different materials from the carrier film. Such a process offers the advantage that used transfer films are not thrown away, but are reprocessed, with the result that further life cycles result. The transfer film according to the invention and/or the production process according to the invention and/or the transfer film used in the recycling process according to the invention is preferably produced and constructed according to the “Design for Recycling (DfR)” principle. This offers substantial economic and ecological advantages as the production of new plastics can be dispensed with. Through the removal of the transfer ply, plastic material that is as pure as possible is obtained, which can be used to produce new carrier film and/or other plastic components.

### BRIEF DESCRIPTION OF THE DRAWINGS

In the following, the invention is explained by way of example with reference to several embodiment examples with the aid of the accompanying drawings. The embodiment examples shown are therefore not to be understood as limitative.

FIG. 1 shows a schematic representation of a transfer film

FIG. 2 shows a schematic representation of a transfer film

FIG. 3 shows a schematic representation of a transfer film

FIG. 4 shows a schematic representation of a transfer film

FIG. 5 shows a schematic representation of a recycling process for a transfer film

FIG. 6 shows a schematic representation of a recycling process for a transfer film

FIG. 7 shows a schematic representation of a recycling process for a transfer film

FIG. 8 shows a schematic representation of a recycling process for a transfer film

FIG. 9 shows a schematic representation of a recycling process for a transfer film

FIG. 10 shows a schematic representation of a recycling process for a transfer film in the roll-to-roll process

### DETAILED DESCRIPTION

FIG. 1 shows a schematic representation of a transfer film 1. The transfer film 1 is preferably a recyclable transfer film 1, in particular a transfer film 1 recyclable in an alkaline washing liquid 9 or lye. The transfer film 1 has a carrier film 2, a detachment layer 3 and a transfer ply 4 applied to the detachment layer 3. The transfer ply 4 has an alkali-soluble topcoat 5 as first layer or uppermost layer. By first layer of the transfer ply 4 is meant the layer which is deposited first during the production of the transfer film 1. Alternatively, the uppermost layer of the transfer ply 4 is meant the layer which forms the uppermost layer of the transfer ply 4 after the application of the transfer ply 4 to a target substrate. The alkaline soluble topcoat 5 is arranged, in particular directly, on the detachment layer 3. The transfer ply 4 of the transfer film 1 according to FIG. 1 in addition also has a primer layer 6, which is arranged under the topcoat 5.

It is thus possible in particular here for a ply arranged on the carrier film 2, such as for example the transfer ply 4, to denote a ply which is not in direct contact with the carrier film 2, but is joined to the carrier film 2 via one or more further layers, such as for example via at least the detachment layer 3.

The transfer film 1 shown in FIG. 1 is a non-metallized hot-stamping film. Alternatively, the transfer film 1 can also be a metallized hot-stamping film, a cold-stamping film or a thermal transfer film, such as is further described for example in the subsequent embodiment examples.

The carrier film 2 is preferably produced by means of extrusion, in particular flat film extrusion. The layer thickness of the carrier film 2 preferably lies in a range of from 4.5 μm to 100 μm, preferably in a range of from 4.5 μm to 12 μm. It is possible for the carrier film 2 to be colorless, transparent, crystal clear, opaque, dyed, at least partially dyed or colored.

The carrier film 2 consists in particular of or comprises in particular polyester. The carrier film 2 preferably comprises or consists of one or more components or composite materials selected from polyethylene terephthalate (PET), polylactide, polyethylene furanoate, polybutylene terephthalate, polytrimethylene terephthalate, polyethylene naphthalate, and/or from polyester carbonate, cellophane, cellulose acetate, polyvinyl chloride, polyimide, polyvinylidene chloride and/or paper, in particular coated and/or laminated paper.

The carrier film 2 shown in FIG. 1 is a PET carrier film 2, which is insoluble in an alkaline washing liquid 9. The carrier film 2 has for example a main constituent, preferably PET. The proportion of this main constituent, preferably the PET, in the carrier film 2 is preferably more than 97%, preferably more than 99.9%, particularly preferably more than 99.97%.

The detachment layer 3 is preferably a non-water-soluble detachment layer. Non-water-soluble detachment layers make it possible to transfer the transfer ply 4 to a substrate surface in the application process and allow a very precise control of the detachment forces and softening temperatures. The detachment layer 3 has in particular a material or a combination of materials selected from: waxes, silicones, polyurethanes, fluorinated compounds, fluorinated fatty acids, modified silicone waxes and silicone resins, unmodified silicone waxes and silicone resins, polymers, preferably acrylate copolymers, polyester copolymers, polystyrene copolymers, polycarbonate copolymers. It is also possible for the detachment layer 3 to comprise fluorinated compounds, such as polytetrafluoroethylene, and/or fluorinated fatty acids and/or modified silicone waxes and resins and/or unmodified silicone waxes and silicone resins or combinations of the above-named components.

Furthermore, the detachment layer 3 can be an aqueous or solvent-based wax detachment layer. The detachment layer 3 is preferably alkali-insoluble. This offers the advantage that during the recycling of the transfer film 1 the detachment layer 3 does not dissolve in the alkaline washing liquid 9. The alkaline washing liquid 9 is thus prevented from having to be reprocessed in a complex manner after the recycling process.

The detachment layer 3 preferably has a layer thickness of the dried layer in the range of from 0.001 μm to 0.080 μm, preferably from 0.004 μm to 0.050 μm. It is preferably provided that the detachment layer 3 is applied by means of a gravure printing process with an application weight of the dried layer in the range of from 0.001 g/m² to 0.060 g/m², preferably from 0.005 g/m² to 0.050 g/m².

In particular, it is possible for the detachment layer 3 to be at least partially transferable with the transfer ply 4. In other words, it is possible for the detachment layer 3, if it is not a reject, to be or to have been transferred to a substrate with the transfer ply 4 in an application process. This is in particular dependent on the composition of the detachment layer 3. In the case where the detachment layer 3 together with the transfer ply 4 is transferred to a target substrate, it is provided in particular that the detachment layer 3 is transparent.

In particular, the detachment layer 3 improves the transfer of the transfer ply 4 in an application process, for example selected from: transfer process, hot-stamping process, cold-stamping process, laminating process, insert-molding process, in-mold decoration process, to a substrate surface, because the detachment force for detaching the transfer ply 4 from the carrier film 2 is preferably set thereby.

In particular, it is provided that the detachment force for detaching the transfer ply 4 from the carrier film 2, in particular at temperatures in the range of from 15° C. to 35° C., lies in a range of from 1 cN/cm to 10 cN/cm, in particular in the case of cold-stamping films preferably in the range of from 1 cN/cm to 3 cN/cm, and/or in particular in the case of hot-stamping films preferably in the range of from 2 cN/cm to 5 cN/cm.

It is preferably possible for the smallest detachment force within or between two or more layers of the transfer ply 4 to be at least twice as large as the force for detaching the transfer ply 4 from the carrier film 2, in particular to lie in a range of from 10 cN/cm to 100 cN/cm, preferably at least 20 cN/cm to 100 cN/cm, particularly preferably at least 40 cN/cm to 100 cN/cm. This guarantees that the adhesion of the individual layers of the transfer ply 4 is sufficiently high, with the result that a breaking or splitting of the transfer ply 4 during the application process is prevented.

As already mentioned above, the topcoat 5 is alkali-soluble. That is to say as soon as the topcoat 5 is put into an alkaline washing liquid 9 or lye, it dissolves therein. In particular at least 40% to 100% of the topcoat 5 comprises a binder or binder mixture, which is at least 50%, preferably at least 75%, soluble in an alkaline washing liquid 9, in particular lye or alkaline solution, with a pH greater than 8.5, preferably greater than 10. In particular, such binders are referred to as ASRs (ASR=alkali-soluble resins) and comprise hydrophobic areas and carboxylic acid groups. These functional groups are, as the pH increases, deprotonated at suitable alkaline pH and increase the polarity of the polymer such that it becomes completely soluble in a polar solvent such as water or is present at least as a colloidal dispersion. The deprotonation is a reversible process. The binder is insoluble in neutral water (pH ˜7) or acidic aqueous solutions (pH less than 7) as the hydrophobic character of the binder predominates in the case of protonated carboxylic acid groups.

ASRs allow the formulation of environmentally friendly water-based varnishes, which by definition contain less than 20% volatile organic compounds (VOCs). An alkaline pH can be set by adding ammonia NH₃ or amines; ammonia is preferably used as, in contrast to amines, it is not regarded as a VOC and because of the very low boiling point of −33° C. can be completely removed by drying in particular in gravure printing coating processes at very high speeds. To improve the wetting, the progression and the film formation, up to 20% hydrophilic organic solvents can be added to improve the film formation; these can be e.g. alcohols or glycol ethers.

The alkali-soluble binder preferably comprises alkali-soluble acrylate polymers, which are typically used in the printing ink sector or in the grinding and dispersing of pigment pastes. Examples of commercially available alkali-soluble acrylates are NeoCryl BT-24 EU, NeoCryl BT-21, NeoCryl BT-100, NeoCryl BT-107-S, NeoCryl BT-101 from Covestro, and SOLURYL R-90, SOLURYL CE-1217 from Hanwha Chemical. Suitable ASRs have in particular a molecular weight below 300000 g/mol, preferably in the range 1000 to 100000 g/mol, particularly preferably in the range 1500 to 60000 g/mol.

The alkali-soluble acrylate preferably has a high acid number, which traces back to carboxylic acid functions which form anionic groups in alkaline aqueous solution. The acid number of the alkali-soluble acrylate, in particular of the alkali-soluble topcoat 5, is preferably at least 20 mg KOH/g, preferably at least 50 mg KOH/g. In order to prevent a low resistance of the dry varnish film to the action of neutral water, the acid number of the polymer particularly preferably lies in the range of from 50 mg KOH/g to 225 mg KOH/g. The alkali-soluble acrylate preferably has a glass transition temperature in the range of from 30° C. to 150° C., particularly preferably in the range 50° C. to 150° C. If a mixture of two or more alkali-soluble binders is used, the glass transition temperature range relates to the calculated proportionately weighted value.

The aqueous topcoat 5 preferably has a solids content in the range of from 5% to 45%, preferably in the range of from 15% to 30%, particularly preferably in the range of from 15% to 25%, in order to obtain an advantageous printing viscosity. The topcoat 5 is preferably applied, in particular applied to the detachment layer 3, by means of gravure printing processes or slot die processes with an application weight of the dried layer in the range of from 0.5 g/m² to 20.0 g/m², preferably from 0.8 g/m² to 10.0 g/m². Furthermore, it is preferably provided that the topcoat 5 is applied in the aqueous state and is then dried, wherein alkaline additives are completely or at least partially removed by drying.

In the case of the transfer film 1 shown in FIG. 1, the topcoat 5 preferably has a layer thickness of the dried layer in the range of from 0.2 μm to 20.0 μm, preferably in the range of from 0.4 μm to 8 μm.

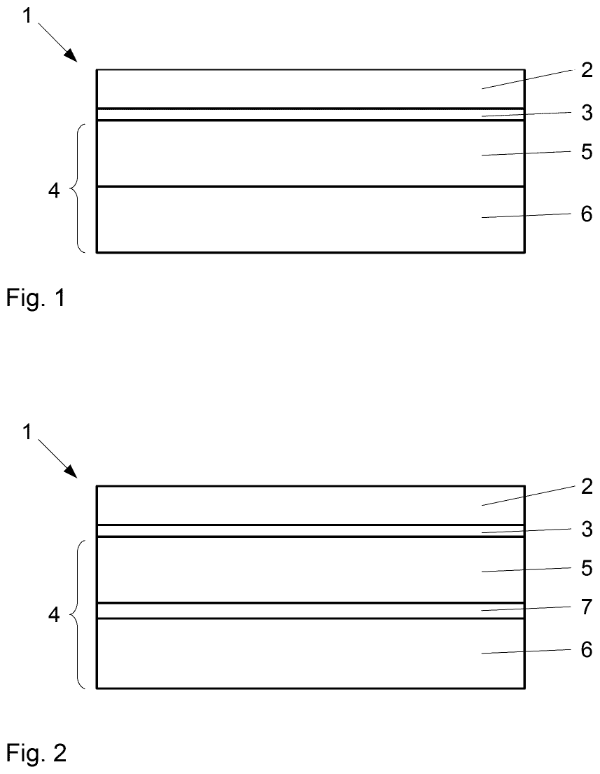

Furthermore, the topcoat 5 can preferably contain matting agents and/or soluble dyes and/or pigments which have a proportion in the range of from 0% to 60% as further constituents. The choice of the further constituents is dependent on the respective application or the optical design. The topcoat 5 is preferably transparent, semitransparent, transparent dyed, dyed, opaque and/or matte. In combination with a subsequent metal layer 7, as is shown by way of example in FIGS. 2, 3 and 4, a metallic gloss effect is generated in particular. In the case of non-metallized transfer films, like such a transfer film 1 in FIG. 1, pigments are preferably used in order to be able to achieve in particular an intense covering power of the transfer ply 4 relative to the substrate surface.

It is preferably provided that the transfer ply 4 has, in particular in addition to the topcoat 5, at least one metal layer 7 and/or at least one primer layer 6 and/or at least one color layer and/or at least one adhesive layer and/or at least one adhesion-promoter layer 8.

In the case of the transfer film 1 shown in FIG. 1, the transfer ply 4 also has, in addition to the topcoat 5, a primer layer 6. The primer layer 6 makes the adhesion of the transfer ply 4 to the target substrate possible in the application process. The primer layer 6 preferably has a layer thickness of the dried layer in the range of from 0.1 μm to 5.0 μm, preferably in a range of from 0.5 μm to 3 μm, wherein preferably in the case of cold-stamping applications the primer layer 6 has a layer thickness of the dried layer in the range of from 0.1 μm to 0.8 μm and in the case of hot-stamping applications the primer layer 6 has a layer thickness of the dried layer in the range of from 0.5 μm to 3 μm. The transfer film 1 shown in FIG. 1 is, as mentioned above, a hot-stamping film. Accordingly, the primer layer 6 of the transfer film 1 according to FIG. 1 has a layer thickness of the dried layer in the range of from 0.5 μm to 3 μm. Furthermore, in this case it is a thermally activatable primer layer 6, which is activated in particular by the thermal energy of a stamping die and/or a stamping roller during the process for applying the transfer ply 4 to a target substrate.

In some cases, in the case of non-metallized transfer films, as shown for example in FIG. 1, the primer layer 6 can be combined with the protective varnish layer. In this case, this combined layer would be water-based and would therefore be dissolved in the alkaline washing liquid 9 or the lye during the recycling process, with the result that during the recycling only the carrier film 2, possibly with detachment layer 3, and the alkaline washing liquid 9 remain as products. In the case of the transfer film 1 shown in FIG. 1, the primer layer 6 is, however, alkali-insoluble. This offers the advantage that during the recycling of the transfer film 1 the primer layer 6 does not dissolve in the alkaline washing liquid 9. The alkaline washing liquid 9 is thus prevented from having to be reprocessed in a complex manner after the recycling process.

It is preferably provided that the primer layer 6 comprises or consists of one or more of the following materials: polyurethanes, polyesters, polyamides, polycarbonates, polyureas, polyacrylates and/or copolymers thereof, polymethacrylates and/or copolymers thereof, hydrocarbon resins, shellac, alkyd resins, colophony resins, ketone resins, phenolic resins, polystyrene resins, epoxy resins, maleic resins, melamine resins, formaldehyde resins, polyvinyl acetates, ethylene-vinyl acetate copolymers, polyvinyl chloride, nitrocellulose, polyolefins, modified polyolefins and/or plasticizers and/or dyes and/or organic and/or inorganic pigments and/or matting agents.

The primer layer 6 is preferably is applied by means of a printing process and/or by means of pouring and/or by means of doctor blade.

A schematic representation of a further transfer film 1, in particular a recyclable transfer film 1, is represented in FIG. 2. The transfer film 1 shown in FIG. 2 is a metallized hot-stamping film. The layer structure of the transfer film 1 shown in FIG. 2 is identical to the layer structure of the transfer film 1 from FIG. 1, but with the difference that a metal layer 7 is further arranged between the primer layer 6 and the topcoat 5. The metal layer 7 ensures a metallic gloss and mirror effect, which can be perceived by an observer. The transfer ply 4 of the transfer film 1 shown in FIG. 2 thus comprises a topcoat 5, a metal layer 7 and a primer layer 6.

The metal layer 7 preferably has a layer thickness in a range of from 5 nm to 50 nm, preferably in a range of from 10 nm to 40 nm. The metal layer 7 preferably comprises materials and/or compounds, preferably with a high refractive index, selected individually or as an alloy of at least two of these materials or as a eutectic from: aluminum, chromium, silver, gold, copper, nickel, tin, indium, silicon oxide, magnesium oxide, titanium oxide, aluminum oxide, zinc oxide, zinc sulfide.

Furthermore, it is preferably provided that the metal layer 7 is transparent or opaque.

In particular, it is possible for the metal layer 7 to be applied as one of the one or more layers of the transfer ply 4 by means of vacuum vapor deposition, in particular wherein the metal layer 7 is applied with a layer thickness in the range of from 5 nm to 50 nm, preferably in the range of from 10 nm to 40 nm.

If the metal layer 7 is formed from a base metal, the metal layer 7 is preferably alkali-soluble. If base metals, such as for example aluminum, are used as metal layer 7, the metal layer 7 dissolves on contact with the alkaline washing liquid 9 or lye. Hydrogen (H₂) is released, which, for reasons of process reliability, is preferably removed from the process by means of thermal utilization, ventilation and/or extraction by suction.

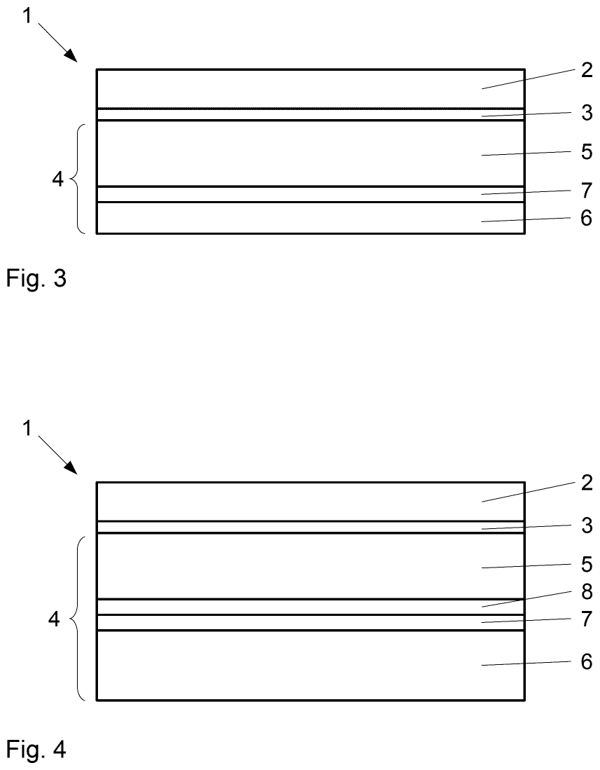

A schematic representation of a further transfer film 1, in particular a recyclable transfer film 1, is represented in FIG. 3. The transfer film 1 shown in FIG. 3 is a metallized cold-stamping film. The layer structure of the transfer film 1 shown in FIG. 3 is identical to the layer structure of the transfer film 1 from FIG. 2, but with the difference that the layer thickness of the primer layer 6 is smaller.

In this case, the primer layer 6 has a layer thickness of the dried layer in the range of from 0.1 μm to 0.8 μm. Unlike in the case of the hot-stamping film according to FIG. 2, the primer layer 6 is not a thermally activatable adhesive.

In particular in the case of a transfer process in the form of cold stamping, an adhesive layer in the shape of a decoration motif is deposited on the substrate preferably via a printing process, such as for example in particular offset printing and/or flexographic printing and/or screen printing and/or inkjet printing. Transfer film 1 is then preferably applied to the substrate in a temperature range of from 10° C. to 40° C., preferably in a range of from 15° C. to 30° C., and then in particular the carrier film 2 is peeled off. If the force of the adhesion of the adhesive layer to the transfer ply 4 is larger than the force for detaching the transfer ply 4 from the carrier film 2, the transfer of the transfer ply 4 to the substrate results. When the carrier film 2 is peeled off, the transfer ply 4 thus remains on the substrate in particular in areas with the adhesive layer and is detached from the carrier film 2 there. In particular, oxidatively and/or radiation-curing adhesives are used for the adhesive layer.

During the cold-stamping process, the primer layer 6 mentioned above has the function of improving the named adhesion between transfer ply 4 and adhesive layer.

A schematic representation of a further transfer film 1, in particular a recyclable transfer film 1, is represented in FIG. 4. The transfer film 1 shown in FIG. 4 is a metallized hot-stamping film. The layer structure of the transfer film 1 shown in FIG. 4 is identical to the layer structure of the transfer film 1 from FIG. 2, but with the difference that an adhesion-promoter layer 8 is further arranged between the metal layer 7 and the topcoat 5.

The adhesion-promoter layer 8 comprises or preferably consists of one or more of the following materials: polyurethanes, polyesters, polyamides, polycarbonates, polyacrylates and/or copolymers thereof, polymethacrylates and/or copolymers thereof, hydrocarbon resins, alkyd resins, colophony resins, ketone resins, phenolic resins, polystyrene resins, epoxy resins, polyvinyl acetates, ethylene-vinyl acetate copolymers, polyvinyl chloride, nitrocellulose, polyolefins and/or modified polyolefins.

The adhesion-promoter layer 8 preferably has a layer thickness in a range of from 0.01 μm to 0.5 μm, preferably in a range of from 0.01 μm to 0.3 μm. The adhesion-promoter layer 8 improves the adhesion between topcoat 5 and metal layer 7. The adhesion-promoter layer 8 is, however, only an optional layer which is necessary in the case of particular metals. In the case of an aluminum coating, for example, an adhesion-promoter layer 8 is not imperative.

Instead of an adhesion-promoter layer 8, the topcoat 5 can also be realized multi-ply. In such a case, all layers of the multi-ply topcoat are preferably alkali-soluble, but the ply of the topcoat in contact with the metal layer can, in addition to an ASR, also contain as a constituent with a proportion of from 40% to 100% in the application weight of the dried layer a proportion of up to 60% of a water-based emulsion or dispersion of one or more of the following materials, in order to set a targeted adhesion to the metal interface without changing the composition of the topcoat lying on top: polyurethanes, polyesters, polyamides, polycarbonates, polyacrylates and/or copolymers thereof, polymethacrylates and/or copolymers thereof, hydrocarbon resins, alkyd resins, ketone resins, phenolic resins, polystyrene resins, epoxy resins, polyvinyl acetates, ethylene-vinyl acetate copolymers, polyvinyl chloride, cellulose esters, polyolefins and/or modified polyolefins.

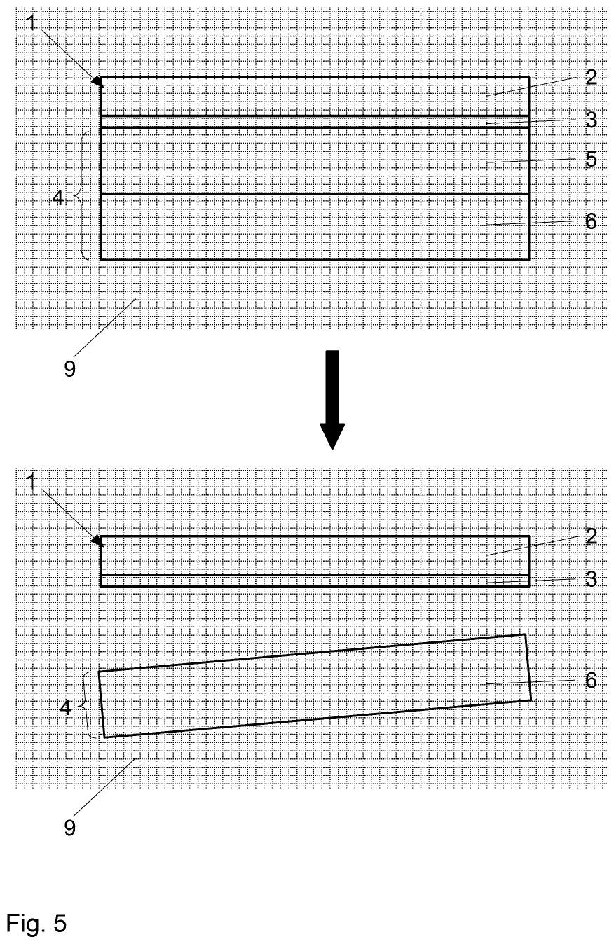

FIG. 5 shows an example process for recycling a transfer film 1, having a carrier film 2 and a transfer ply 4 arranged at least partially on the carrier film 2, wherein a detachment layer 3 is arranged between the carrier film 2 and the transfer ply 4. The transfer ply 4 has an alkali-soluble topcoat 5 and a primer layer 6, wherein the topcoat 5 is arranged on the detachment layer 3. For recycling the transfer film 1, the following step is carried out:
x) dissolving 10 the alkali-soluble topcoat 5, in particular the alkali-soluble binder of the topcoat 5, by means of an alkaline washing liquid 9, preferably in a washing liquid bath, wherein the transfer ply 4 is detached from the carrier film 2.

In particular, the carrier film 2 is cleaned during step x) by means of the alkaline washing liquid 9 or lye. For this purpose, the transfer film 1 is in particular released from the transfer ply 4, with the result that the carrier film 2 substantially remains after step x). It is possible for the detachment layer 3 to remain on the carrier layer. As the layer thickness of the detachment layer 3 is negligibly small in comparison with the layer thickness of the carrier film 2, the remaining detachment layer 3 has no negative effect on the further recycling process. Rather, it is guaranteed that even if the detachment layer 3 remains on the carrier film 2 after step x) that the carrier film 2 and/or the material of the carrier film 2 has a purity in the range of from 99.0 wt.-% to 100.0 wt.-% after step x). In the case of a carrier film 2 made of PET, this means that 99% to 100% of the carrier film 2 obtained from the recycling process consists of pure PET. Thus, the recycled material preferably has almost the same material properties as newly obtained material.

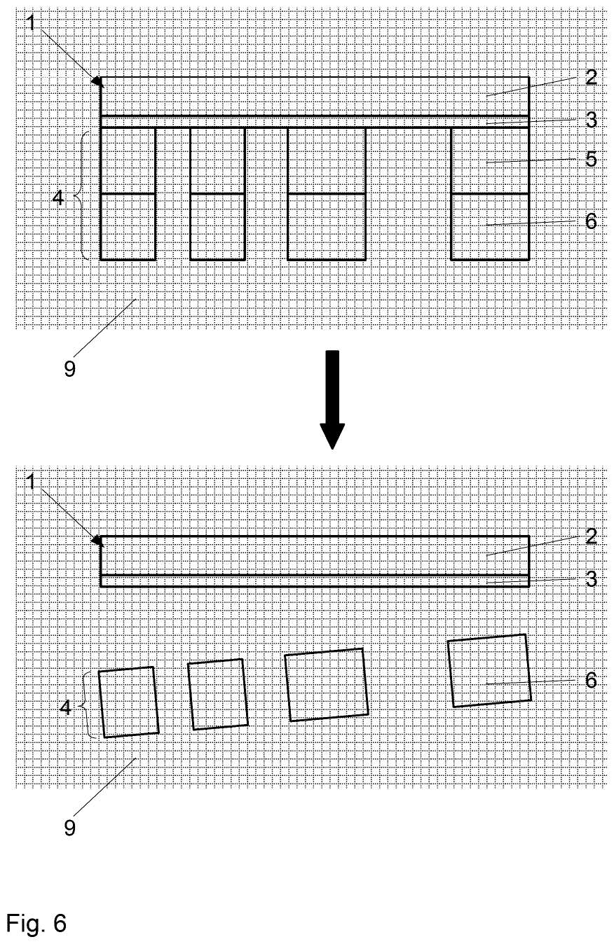

With a carrier film 2 as shown by way of example in FIGS. 5 and 6, it is possible in particular for the carrier film 2 in its entirety to be guided through the alkaline washing liquid 9. It is possible for the transfer ply 4 to be present likewise in its entirety on the carrier film 2, for example if the transfer film 1 represents a reject, or for the transfer ply 4 to be present in the form of transfer ply constituents on the carrier film 2. The transfer ply constituents are for example the residual transfer ply, which has remained on the carrier ply after a partial transfer of the transfer ply 4 to a substrate. However, it is alternatively also possible for the transfer film 1 to be comminuted beforehand by means of a comminution device, with the result that cut material forms, which is put into the alkaline washing liquid 9. By the carrier film 2 is therefore preferably meant both the carrier film 2 in its entirety and a multiplicity of carrier film cuttings. By the transfer ply 4 is preferably meant both the transfer ply 4 in its entirety and a multiplicity of transfer ply cuttings.

Preferably before step x) the transfer film 1 has in particular a structure which is described in relation to FIGS. 1 to 4.

As can be seen in FIG. 6, it is possible for the transfer ply 4 not to be present in areas in which the detachment layer 3 is present. Here, the carrier film 2 with the detachment layer 3 was detached from the transfer ply 4 in these areas for example in a preceding application process for transferring the transfer ply 4 to a target substrate. Further, it is possible for the detachment layer 3 to have been transferred to a target substrate with the transfer ply 4 in a preceding application process, with the result that the detachment layer 3 is not present in the areas without transfer ply 4 before step x). Detachment layers transferred to a substrate with the transfer ply 4 preferably have a high level of transparency, in particular a transmittance of from 95% to 100%, preferably in a wavelength range of from 350 nm to 800 nm, in particular averaged over this wavelength range.

In step x) the alkaline washing liquid 9 or lye soaks into the transfer film 1, in particular into the transfer ply and/or between carrier film and transfer ply, for example via cut edges and/or broken edges and/or diffuses through alkali-insoluble transfer ply layers and begins to dissolve the alkali-soluble topcoat 5 on contact with the alkaline washing liquid 9 or lye. Furthermore, microdamage in the transfer ply 4, in particular microcracks, forms during the application or film processing. Through these microcracks, the alkaline washing liquid 9 or lye can also advantageously soak into the transfer film, in particular into the transfer ply and/or between carrier film and transfer ply. As the topcoat has a comparatively large application weight of the dried layer or a comparatively large layer thickness relative to the rest of the layers of the transfer ply 4, the reaction surface via which the alkaline washing liquid 9 soaks into the topcoat 5 is comparatively large. This has an advantageous effect on the dissolution process and accelerates the dissolution 10 of the topcoat 5, in particular of the alkali-soluble binder of the topcoat 5. The topcoat 5 preferably swells on contact with the alkaline washing liquid 9 or the lye, with the result that the separation of the rest of the transfer ply 4 from the carrier film 2 is further promoted.

As shown in FIGS. 5 and 6, the topcoat 5, in particular the alkali-soluble binder of the topcoat 5, dissolves completely in the alkaline washing liquid 9, with the result that the separated carrier film 2 and the rest of the transfer ply layers remain. The rest of the transfer ply constituents preferably occur in the form of particles. Thus, the particles in the washing liquid 9 form a heterogeneous mixture, whereas the dissolved topcoat 5 remains in the washing liquid 9 and forms a homogeneous mixture with it. The layers of the transfer ply 4 which are not the topcoat 5 preferably do not dissolve. As mentioned above, however, when base metals are used as metal layer 7 they can dissolve in the alkaline washing liquid 9 or the lye.

The alkaline washing liquid 9 can for example be an aqueous alkaline solution, an alkaline solution and/or a lye. The alkaline washing liquid 9 preferably comprises one or more solutions of the following solutions: solutions of alkali metal or alkaline earth metal hydroxides, such as potassium hydroxide, sodium hydroxide or calcium hydroxide; or alkaline earth oxides, such as calcium oxide or barium oxide; or solutions of ammonia or amines.

In addition, it is schematically shown in FIG. 6 that the transfer ply 4 is present as particles in the alkaline washing liquid 9 after the separation from the carrier film 2. It is preferably provided that during step x) the transfer ply 4 disintegrates into particles, wherein the particles are insoluble in the alkaline washing liquid 9, in particular wherein the particles, in the case of a planar observation of the particles, have a size in the range of from 10 μm to 50 mm, preferably in the range of from 50 μm to 5 mm, particularly preferably in the range of from 20 μm to 5 mm. Insoluble particles of the transfer ply 4 can preferably be separated from the alkaline washing liquid 9 by means of a separation process after step x), in particular wherein the separation process comprises filtration and/or centrifugation and/or sieving and/or decantation. Because no nanoscale particles form during the recycling process according to the invention, complex separation steps, such as for example a complex filtration for removing the nanoscale particles, can be dispensed with. As a result, it is in addition ruled out that nanoscale particles stick to the carrier film 2 and thus the purity of the recyclate or the effort for achieving a particular purity is improved. Further, in particular the recoverability of the alkaline washing liquid 9, the maintenance and repair effort and the process reliability is improved. The alkali-soluble topcoat 5 advantageously makes this possible in that no or only particularly small mechanical forces, which could cause a separation of very fine particles, are used in particular to separate the transfer ply 4 from the carrier film 2 in step x).

The particles are present in particular in undissolved form in the alkaline washing liquid 9 and/or the particles in the alkaline washing liquid 9 cohesively have the entire layer structure of the transfer ply 4 minus the topcoat 5 dissolved in the washing liquid 9. In other words, it is possible for the layer structure of the carrier film 2 and/or of the transfer ply 4 of the transfer film 1 to be preserved during step x), as the transfer ply 4 is insoluble in the alkaline washing liquid 9.

However, as mentioned above, as both the topcoat 5 and if applicable the metal layer 7 dissolves in the alkaline washing liquid 9 or lye when base metals are used, it is provided in particular that the alkaline washing liquid 9 is reprocessed by means of membrane filtration and/or chemical precipitation after step x). The dissolved constituents of the topcoat 5 and if applicable of the metal layer 7 can thereby be removed from the alkaline washing liquid 9 again, with the result that the alkaline washing liquid 9 can be used again for a further subsequent recycling process.

It is expedient for the cut material in the alkaline washing liquid 9 to have a concentration in the range of from 1 wt.-% to 30 wt.-%, preferably from 5 wt.-% to 15 wt.-%, during or after step x). The concentration is calculated in particular from the ratio of the sum of the weight of transfer ply 4 present in the alkaline washing liquid 9 to the weight of the alkaline washing liquid 9 with the topcoat 5 dissolved in the alkaline washing liquid 9, and with the transfer ply 4. It is thus preferably substantially the solids concentration in the washing liquid 9 with the transfer ply 4.

The time required until the alkali-soluble topcoat 5 has been dissolved in step x) and the particle size of the precipitated particles of the transfer ply 4 are dependent in particular on the pH of the alkaline washing liquid 9, the temperature of the alkaline washing liquid 9, the stirring speed in the washing liquid 9 and the quantity of cut material or quantity of transfer film 1 in the recycling container and/or in the washing liquid bath. The higher the pH of the alkaline washing liquid 9 and the higher the temperature of the alkaline washing liquid 9 and the higher the stirring speed in the alkaline washing liquid 9 are, the faster the dissolution 10 of the alkali-soluble topcoat 5, in particular of the alkali-soluble binder of the topcoat 5, is effected and the smaller the particles of the transfer ply 4 are produced. The choice of the parameters is preferably to be made such that the formation of nanoscale particles is prevented. Further, it is possible, through the choice of the corresponding geometry and the volume of the recycling container, in particular a container for the washing liquid bath, the fill level of the alkaline washing liquid 9, the quantity of transfer film 1, in particular in the form of cut material, per run and the stirring duration as well as stirring speed, to prevent the constituents of the carrier film 2 and/or of the transfer ply 4 and/or of the cut material from sticking together and/or folding together.

It is preferably provided that step x) is carried out at ambient temperature, in particular in a temperature range of from 15° C. to 30° C. In other words, this means that the alkaline washing liquid 9 in step x) has the ambient temperature, in particular a temperature in the range of from 15° C. to 30° C. However, it is conceivable that step x) is carried out in the entire temperature range in which the alkaline washing liquid 9 is in the liquid aggregate state. Step x) is advantageously carried out at higher temperatures than ambient temperature, in particular at more than 30° C., as the time until detachment of the transfer ply is thus minimized.

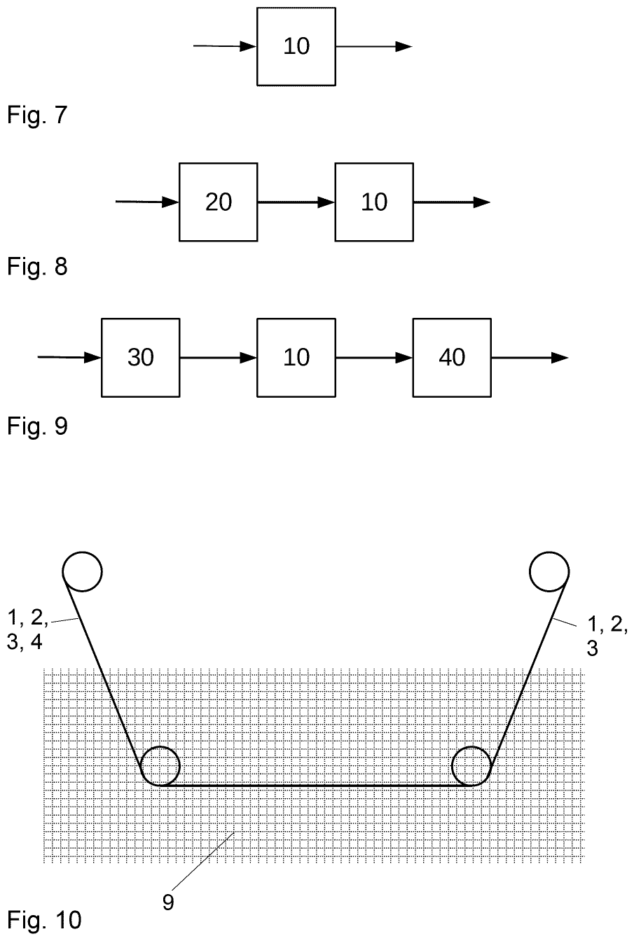

An example process for recycling a transfer film 1 with the dissolution 10 of the alkali-soluble topcoat 5, in particular of the binder of the topcoat 5, in step x) is shown in FIG. 7.

It is preferably provided that in step x) the alkaline washing liquid 9 has a pH greater than 9, preferably greater than 11, particularly preferably greater than 13. However, it is also possible for the alkaline washing liquid 9 to have a pH of 14 or more. Generally, the higher the pH of the alkaline washing liquid 9 is, the faster the alkali-soluble topcoat 5 is dissolved and the faster the rest of the transfer ply separates from the carrier film 2.

FIG. 8 shows an example process for recycling a transfer film 1 with the dissolution 10 of the alkali-soluble topcoat 5, in particular of the alkali-soluble binder of the topcoat 5, in step x) and the following step, which is carried out in particular before the dissolution 10 of the alkali-soluble topcoat 5, in particular of the alkali-soluble binder of the topcoat 5:
a) comminuting 20 the transfer film 1, by means of a cutting device, into cut material, preferably wherein the transfer film 1 is present wound onto a roll.

It is hereby possible to put the transfer film 1 into the alkaline washing liquid 9 in the form of cut material. It is advantageously thereby made possible for the alkaline washing liquid 9 to soak into the transfer film 1, in particular into the transfer ply 4 and/or between carrier film 2 and transfer ply 4, better via cut edges and broken edges.

The cut material, in particular when observed perpendicular to a plane spanned by the cut material, preferably has in each case a surface area in the range of from 0.1 cm² to 100 cm², preferably from 1 cm² to 10 cm². As a result, it is in particular also guaranteed that, if the layer thickness of the transfer ply 4 is for example smaller than 50 μm, the transfer ply particles are large enough.

Further, it is preferably provided that before step a) the transfer film 1 is present rolled onto a roll. In this case, it is preferably possible for the following step to be further performed before the comminution 20, in particular in step a): transporting the roll to the cutting device by hand and/or by means of a feeder.

It can also be provided that during the comminution 20 of the transfer film 1 in step a) the wound transfer film 1 is cut into film webs, wherein the roll with the transfer film 1 is fixed in a V-shaped depression, in particular is fixed horizontally, and is then cut open to the film core in the longitudinal direction by means of a blade, in particular from above or from below or from the side, and the film core is removed, in particular if there is a film core. This has the advantage that the transfer film is easily detached from the film core quickly and can be used for further processing.

In particular, it is possible for the cutting device to cut and/or chop and/or shred and/or tear the transfer film 1 during the comminution 20, in particular in step a).

In particular if a comminution 20 of the transfer film 1 according to step a) is carried out before step x), it is provided that the alkaline washing liquid 9 is stirred with the transfer film 1 and/or the cut material. The stirring promotes the soaking of the alkaline washing liquid 9 into the transfer film 1 and thus accelerates the separation of the transfer ply 4 from the carrier film 2.

Furthermore, it is possible for the alkaline washing liquid 9 to be stirred with the transfer film 1 and/or the cut material during step x), in particular if step a) is carried out beforehand, with a stirring duration in a range of from 30 seconds to 120 seconds, preferably from 60 seconds to 120 seconds.

Further, it is also possible for the alkaline washing liquid 9 to be stirred with the transfer film 1 and/or the cut material during step x), in particular if step a) is carried out beforehand, with a stirring speed of a stirrer in a range of from 1 to 200 revolutions, preferably 10 to 50 revolutions, per minute. The higher the stirring speed is, the faster the transfer ply 4 detaches from the carrier film 2. In addition, the stirring has a positive effect such that low shear forces are generated in the washing liquid 9, which promote the detachment of the transfer ply 4 from the carrier film 2.

In particular if the comminution 20 according to step a) is carried out before step x), carrier film cuttings also form in addition to the previously mentioned particles of the transfer ply 4. The surface area of the carrier film cuttings, in particular when observed perpendicular to a plane spanned by the carrier film cutting, preferably corresponds to the surface area of the cut material. In other words, this means that the recycling process is particularly gentle for the material of the carrier film 2 or the carrier film cuttings and no particles are detached from the carrier film 2 per se.

After the transfer ply 4 has been detached from the carrier film cuttings in step x), it is provided in particular that the carrier film cuttings are separated from the alkaline washing liquid 9 by means of filtration and/or centrifugation and/or sedimentation. While filtration and/or centrifugation describe mechanical separation processes, sedimentation is based on a physical effect. Here, the difference in density of the individual constituents of the transfer film 1 is utilized. For example, a PET carrier film has a density of approx. 1.4 g/cm³, whereas the materials of the layers of the transfer ply 4, for example of the primer layer 6 or of the adhesion-promoter layer 8, have a density in the range of from 0.9 g/cm³ to 1.25 g/cm³. Through targeted setting of the density of the alkaline washing liquid 9, a separation of the carrier film 2 or the carrier film cuttings from the particles of the transfer ply 4 can be achieved. In particular, it is provided that the alkaline washing liquid 9 has a density in the range of from 1.2 g/cm³ to 1.4 g/cm³, preferably in the range of from 1.25 g/cm³ to 1.35 g/cm³, in particular wherein the density of the alkaline washing liquid 9 is chosen such that a sedimentation of the carrier film 2 takes place due to difference in density.

The density of the alkaline washing liquid 9 can, for example when sodium hydroxide solution or potassium hydroxide solution is used, be set very precisely via the quantity of dissolved NaOH or KOH depending on the temperature.

Furthermore, it is also possible for a combination of the above-named separation processes to take place. For example, a pre-separation by means of sedimentation and then a fine separation by filtration and/or centrifugation can take place.

After the detachment in step x) it is provided in particular that the separated carrier film cuttings are washed and/or neutralized and/or dried, preferably by means of a mechanical and/or thermal drying process, in particular wherein a purity of the carrier film cuttings, in particular the carrier film material, in a range of from 99% to 100% is achieved. Possible contaminations are to be attributed merely to the detachment layer 3, which in some circumstances still remains on the carrier film 2 either over the whole surface or only in areas which were not transferred to a target substrate beforehand. As the detachment layer 3 has a negligibly thin layer thickness compared with the layer thickness of the carrier film 2 however, a purity of over 99% of the carrier film material can still be guaranteed.

Advantageously, it is possible for the carrier film cuttings to have a moisture in the range of from 0% to 15%, preferably from 0% to 5%, after the drying. Through the drying, it is guaranteed in particular that no further substances which are contained in the washing liquid 9 also flow into the subsequent process steps if applicable.

As an alternative to the washing of cut material, it is also possible for the recycling process to be carried out in a roll-to-roll process. This is shown schematically in FIGS. 9 and 10. For this purpose, it is preferably provided that the process has the following step before step x):
b1) unwinding 30 the transfer film 1 from a feed roll by means of an unwinding device, wherein the unwound transfer film 1 is brought into contact with the alkaline washing liquid 9, in particular by guiding the transfer film 1 into a washing liquid bath.

In particular, the transfer film 1 is guided into the washing liquid bath for this purpose, for example by means of one or more deflection rollers.

The process preferably has the following step after step b1) and after step x):
b2) winding 40 the carrier film 2 onto a take-up roll, wherein the carrier film 2 is guided out of the bath of the alkaline washing liquid 9, in particular wherein the topcoat 5 in dissolved form and/or the transfer ply 4 in undissolved form remains in the alkaline washing liquid 9.

Here, in particular, the separation of the carrier film 2 can be dispensed with because the carrier film 2 can be easily pulled out of the alkaline washing liquid 9 again preferably by the winding 40.

The transfer film 1, in particular the carrier film 2, is preferably guided through the washing liquid 9, preferably between step b1) and step b2), at a speed of from 1 m/s to 100 m/s. In particular, the transfer film 1, in particular the carrier film 2, is brought into contact with the washing liquid 9 and/or guided through the washing liquid bath, preferably between step b1) and step b2), for a duration in a range of from 10 s to 150 s.

In particular, it is possible to increase the residence time by means of the one or more deflection rollers and/or to accelerate the dissolution of the alkali-soluble topcoat 5, for example because of the friction between transfer ply 4 and washing liquid 9 and/or between the alkali-soluble topcoat 5 and the washing liquid 9.

Further, it is possible for the carrier film 2 to be guided through a cleaning bath, after the carrier film 2 has been guided out of the washing liquid bath. Here, the carrier film 2 is preferably brought into contact with a neutralizing cleaning liquid, which preferably contains one or more materials selected from water or alternatively a homogeneous mixture of water with one or more further substances. In particular, acids, preferably selected individually or in combination from carbonic acid, acetic acid, hydrochloric acid, sulfuric acid, and/or one or more alcohols, preferably selected individually or in combination from methanol, ethanol, n-propanol, isopropanol, acetone, are used as one or more further substances. Further, it is possible to add additives and/or surfactants, such as for example defoamers, to the washing liquid 9. Before the winding 40 onto the take-up roll, the carrier film 2 is preferably guided out of the cleaning bath again.

It is also possible for the carrier film 2 to be dried after the carrier film 2 has been guided out of the washing liquid bath and/or the cleaning bath.

The process is thus carried out in particular in a roll-to-roll process and/or steps b1), x) and b2) are carried out in an inline process. An embodiment example is also conceivable in which the production process and/or the application process for the transfer film are carried out in an inline process in the process for recycling the transfer film, in particular with steps b1, x) and b2).

It is also conceivable that a mechanical abrasion system and/or a brush roll system and/or a foam roll system and/or a spray nozzle system is additionally used to detach the transfer ply 4 from the carrier film 2 in step x) and/or between steps b1) and b2).

Similarly to the previously described embodiment examples according to FIGS. 4 to 8, in the roll-to-roll process particles of the transfer ply 4 form, which form a heterogeneous mixture with the alkaline washing liquid 9. In the roll-to-roll process these particles of the transfer ply 4 are separated from the alkaline washing liquid 9 analogously to the above-described separation processes. The same also applies to the topcoat 5 dissolved in the alkaline washing liquid 9. The constituents thereof are likewise removed from the washing liquid 9.

Both in the roll-to-roll process and in the process with comminution the starting material is preferably the same, i.e. the transfer film 1 is preferably present wound onto a roll. Before step x), in particular before step a) and/or b1), the transfer film 1 preferably has a proportion of adhesive strips and/or splicing tapes in the range of from 0 wt.-% to 0.5 wt.-%, preferably from 0 wt.-% to 0.1 wt.-%. Such adhesive strips or splicing tapes are regarded as foreign materials, which are likewise separated from the carrier film 2. It is preferably provided that before step x), in particular before step a) and/or before step b1), the transfer film 1 has a foreign material proportion in the range of from 0 wt.-% to 5 wt.-%, preferably from 0 wt.-% to 1 wt.-%.

Furthermore, it is also possible for the carrier film 2 and/or the carrier film cuttings and/or the material of the carrier film 2 to be further processed into a compact product and/or extrusion product after step x), in particular wherein the compact product and/or the extrusion product is suitable for at least one subsequent process or a combination of processes selected from: injection molding, extrusion, flat film extrusion, pressing processes, compounding, chemical recycling and/or energy recovery.

### LIST OF REFERENCE NUMBERS

1 transfer film
2 carrier film
3 detachment layer
4 transfer ply
5 topcoat
6 primer layer
7 metal layer
8 adhesion-promoter layer
9 alkaline washing liquid
10 dissolution of the alkali-soluble topcoat
20 comminution
30 unwinding
40 winding

1. A transfer film having a carrier film and a transfer ply arranged at least partially on the carrier film, wherein a detachment layer is arranged between the carrier film and the transfer ply, and
wherein the transfer ply has an alkali-soluble topcoat, wherein the topcoat is arranged on the detachment layer.

2. The transfer film according to claim 1, wherein at least 40% to 100% of the topcoat comprises a binder or binder mixture, which is at least 50% soluble in an alkaline washing liquid with a pH greater than 8.5.

3. The transfer film according to claim 1, wherein the topcoat is transparent, semitransparent, transparent dyed, dyed, opaque and/or matte.

4. The transfer film according to claim 1, wherein the topcoat has a layer thickness of the dried layer in the range of from 0.2 μm to 20.0 μm.

5. The transfer film according to claim 1, wherein the detachment layer has an application weight of the dried layer in the range of from 0.001 μm to 0.080 μm.

6. The transfer film according to claim 1, wherein the detachment layer is formed transparent and/or translucent and/or opaque and/or dyed and/or at least partially dyed and/or crystal clear.

7. The transfer film according to claim 1, wherein the transfer ply has further layers selected individually or in combination from: at least one metal layer, at least one primer layer, at least one color layer, at least one adhesive layer, at least one adhesion-promoter layer, at least one barrier layer, at least one protective layer, at least one replication layer, at least one oxide layer, at least one mask layer.

8. The transfer film according to claim 7, wherein the transfer ply has a primer layer having a layer thickness of the dried layer in the range of from 0.1 μm to 5.0 μm.

9. The transfer film according to claim 7, wherein the transfer ply has an adhesion-promoter layer having a layer thickness in a range of from 0.01 μm to 0.5 μm.

10. The transfer film according to claim 1, wherein the carrier film has a layer thickness in the range of from 4.5 μm to 100 μm.

11. The transfer film according to claim 1, wherein the carrier film comprises a main constituent, wherein the proportion of the main constituent in the carrier film is more than 97%.

12. The transfer film according to claim 1, wherein the carrier film is colorless, transparent, crystal clear, opaque, dyed, at least partially dyed or colored.

13. The transfer film according to claim 1, wherein the detachment force for detaching the transfer ply from the carrier film lies in a range of from 1 cN/cm to 10 cN/cm.

14. The transfer film according to claim 1, wherein the smallest detachment force within or between two or more layers of the transfer ply is at least twice as large as the force for detaching the transfer ply from the carrier film.

15. A process for producing a transfer film, wherein the following steps are carried out:
providing a carrier film;
applying a detachment layer to the carrier film; and
applying one or more layers of a transfer ply, wherein an alkali-soluble topcoat is applied as first layer of the transfer ply such that the topcoat is arranged on the detachment layer.

16. The process for producing a transfer film according to claim 15, wherein the topcoat is applied with an application weight of the dried layer in the range of from 0.5 g/m² to 20.0 g/m².

17. The process for producing a transfer film according to claim 15, wherein the topcoat is applied in the aqueous state and is then dried, wherein alkaline additives are completely or at least partially removed by drying.

18. The process for producing a transfer film according to claim 15, wherein the aqueous topcoat has a solids content in the range of from 5% to 45%.

19. The process for producing a transfer film according to claim 15, wherein the detachment layer is applied by means of a gravure printing process with an application weight of the dried layer in the range of from 0.001 g/m² to 0.060 g/m².

20. The process according to claim 15, wherein a primer layer is applied as one of the one or more layers of the transfer ply by means of a printing process and/or by means of pouring and/or by means of doctor blade.

21. The process according to claim 20, wherein the primer layer is applied with an application weight of the dried layer in the range of from 0.2 g/m² to 5.0 g/m².

22. A process for recycling a transfer film having a carrier film and a transfer ply arranged at least partially on the carrier film, wherein a detachment layer is arranged between the carrier film and the transfer ply, and wherein the transfer ply has an alkali-soluble topcoat, wherein the topcoat is arranged on the detachment layer, and wherein the following step is carried out in the process:
x) dissolving the alkali-soluble topcoat by means of an alkaline washing liquid, wherein the transfer ply is detached from the carrier film.

23. The process according to claim 22, wherein after step x), the carrier film and/or the material of the carrier film has a purity in the range of from 99.0 wt.-% to 100.0 wt.-%.

24. The process according to claim 22, wherein during step x), the topcoat is dissolved in that the alkaline washing liquid soaks into the transfer film and/or between carrier film and transfer ply via cut edges and/or broken edges and/or cracks and/or microcracks of the transfer film.

25. The process according to claim 22, wherein during step x) the transfer ply disintegrates into particles, wherein the particles are insoluble in the alkaline washing liquid.

26. The process according to claim 22, wherein in step x), the alkaline washing liquid has a pH greater than 9.

27. The process according to claim 22, wherein the alkaline washing liquid comprises one or more solutions of the following solutions: solutions of alkali metal or alkaline earth metal hydroxides, or alkaline earth oxides, or solutions of ammonia or amines.

28. The process according to claim 22, wherein the alkaline washing liquid has a density in the range of from 1.2 g/cm³ to 1.4 g/cm³.

29. The process according to claim 22, wherein step x) is carried out at ambient temperature.

30. The process according to claim 22, wherein the following step is carried out before step x) in the process:
a) comminuting the transfer film by means of a cutting device into cut material.

31. The process according to claim 30, wherein in step a), the cut material has in each case a surface area in the range of from 0.1 cm² to 100 cm².

32. The process according to claim 30, wherein the cut material in the alkaline washing liquid has a concentration in the range of from 1 wt.-% to 30 wt.-% during step x).

33. The process according to claim 30, wherein the alkaline washing liquid is stirred with the transfer film and/or the cut material during step x).

34. The process according to claim 30, wherein the alkaline washing liquid is stirred with the transfer film and/or the cut material during step x) with a stirring duration in a range of from 30 seconds to 120 seconds.

35. The process according to claim 30, wherein the alkaline washing liquid is stirred with the transfer film and/or the cut material during step x) with a stirring speed of a stirrer in a range of from 1 to 200 revolutions.

36. The process according to claim 30, wherein the transfer ply of the cut material detaches from the carrier film with the result that particles of the transfer ply and carrier film cuttings form during step x).

37. The process according to claim 36, wherein the carrier film cuttings are separated from the alkaline washing liquid by means of filtration and/or centrifugation and/or sedimentation.

38. The process according to claim 36, wherein the separated carrier film cuttings are washed and/or neutralized and/or dried.

39. The process according to claim 22, wherein the process has the following step before step x):
b1) unwinding the transfer film from a feed roll by means of an unwinding device, wherein the unwound transfer film is brought into contact with the alkaline washing liquid.

40. The process according to claim 39, wherein the process has the following step after step b1) and after step x):
b2) winding the carrier film onto a take-up roll, wherein the carrier film is guided out of the bath of the alkaline washing liquid.

41. The process according to claim 40, wherein a mechanical abrasion system and/or a brush roll system and/or a foam roll system and/or a spray nozzle system is additionally used to detach the transfer ply from the carrier film in step x) and/or between steps b1) and b2).

42. The process according to claim 22, wherein insoluble particles of the transfer ply are separated from the alkaline washing liquid by means of a separation process after step x).

43. The process according to claim 22, wherein the alkaline washing liquid is reprocessed by means of membrane filtration and/or chemical precipitation after step x).

44. The process according to claim 22, wherein the carrier film and/or the carrier film cuttings and/or the material of the carrier film are further processed into a compact product and/or extrusion product after step x).
